(19) United States
(12) Patent Application Publication
(10) Pub. No.: US 2026/0134220 A1
(43) Pub. Date: May 14, 2026

(54) SYSTEMS AND METHODS FOR DYNAMIC CONVERSATIONAL INTERFACES ACCORDING TO DETECTED USER BEHAVIORS

(71) Applicant: PANASONIC WELL LLC, Palo Alto, CA (US)

(72) Inventors: Yoky Matsuoka, Los Altos Hills, CA (US); David Justus, Brooklyn, NY (US); Prerna Kaul, Palo Alto, CA (US); Katlyn Bren Johnson, Palo Alto, CA (US); Mary Christine Virginia Baynham Pitts, Palo Alto, CA (US); Peter Markatos, Palo Alto, CA (US); Anisha Kharkia, Palo Alto, CA (US); Ian Lachmansingh, Palo Alto, CA (US); Dipti Rai, Pleasanton, CA (US)

(21) Appl. No.: 19/340,370

(22) Filed: Sep. 25, 2025

Related U.S. Application Data
(60) Provisional application No. 63/720,573, filed on Nov. 14, 2024.

(51) Int. Cl. G06F 40/35; G06F 40/40; G06N 20/00

(52) U.S. Cl. CPC G06F 40/35; G06F 40/40; G06N 20/00

(57) ABSTRACT

Systems and methods for automatically and continuously processing communications exchanged among users and automated agents and corresponding user behaviors are provided to dynamically generate topical communications sessions from ongoing communications sessions. The topical communications sessions are implemented to reduce the cognitive effort of conversation management within existing communications sessions where topical drift may occur. The framework allows users to submit multimedia inputs that are classified by the systems and methods and automatically routed to appropriate communications containers.

### CROSS-REFERENCE TO RELATED APPLICATIONS

The present application claims the benefit of U.S. Provisional Application 63/720,573 filed Nov. 14, 2024 and is related to U.S. Non-Provisional Application entitled “SYSTEMS AND METHODS FOR PROACTIVE ARTIFICIAL INTELLIGENCE” filed Sep. 25, 2025 (Attorney Docket No.: 109304-847304-008700US), U.S. Non-Provisional Application entitled “MACHINE-LEARNING TECHNIQUES FOR FAMILY PROFILE MANAGEMENT” filed Sep. 25, 2025 (Attorney Docket No.: 109304-847282-009400US) and U.S. Non-Provisional Application entitled “SYSTEMS AND METHODS FOR AUTOMATED USER RELATIONSHIP PROFILING” filed Sep. 25, 2025 (Attorney Docket No.: 109304-847283-009500US), each of which are incorporated herein by reference in their entireties and for all purposes.

### FIELD

The present disclosure relates to systems and methods for automatically and continuously processing communications exchanges among users and automated agents and corresponding user behaviors to dynamically generate topical communications sessions from ongoing communications sessions.

### SUMMARY

Disclosed embodiments provide a framework for generating topic-specific communications sessions that are relevant to different users by automatically and continuously processing communications exchanged amongst these different users and automated agents, and corresponding user behaviors. According to some embodiments, a computer-implemented method is provided. The computer-implemented method comprises receiving conversation data. The conversation data is received during an ongoing communications session among a set of users and an automated agent. The computer-implemented method further comprises dynamically processing the conversation data into a set of communication embeddings. The set of communication embeddings is obtained through language processing of the conversation data. The computer-implemented method further comprises identifying a set of topic embeddings. The set of topic embeddings correspond to one or more topics relevant to the ongoing communications session. Further, the set of topic embeddings is identified through processing of the set of communication embeddings and different topic embeddings according to a set of similarity vectors. The computer-implemented method further comprises generating one or more new communications sessions. The one or more new communications sessions are generated by a generative pre-trained algorithm according to the set of topic embeddings. The computer-implemented method further comprises updating one or more interfaces associated with the set of users to facilitate the one or more new communications sessions. The one or more interfaces are updated according to the one or more topics associated with the set of topic embeddings. The computer-implemented method further comprises updating the generative pre-trained algorithm according to feedback associated with the one or more new communications sessions.

In some embodiments, the computer-implemented method further comprises assigning one or more new automated agents to the one or more new communications sessions. The one or more new automated agents are assigned based on the one or more topics.

In some embodiments, the conversation data includes a user input corresponding to a particular topic of interest to a user of the set of users. Further, the set of topic embeddings corresponds to at least the particular topic.

In some embodiments, the computer-implemented method further comprises processing the conversation data through a trained machine learning algorithm to generate one or more recommendations corresponding to a set of goals. The computer-implemented method further comprises generating another new communications session based on the set of goals.

In some embodiments, the computer-implemented method further comprises processing the conversation data through one or more trained large language models (LLMs) to generate one or more summaries corresponding to communications associated with the one or more topics. The computer-implemented method further comprises providing the one or more summaries through the one or more interfaces.

In some embodiments, generating the one or more new communications sessions further includes determining a set of cognitive load scores associated with the set of users. The set of cognitive load scores is determined based on existing tasks and user profiles associated with the set of users. Generating the one or more new communications sessions further includes selecting a set of topics according to the set of cognitive load scores. The one or more new communications sessions correspond to the set of topics.

In some embodiments, the computer-implemented method further comprises continuously monitoring the one or more new communications sessions to detect new topic embeddings associated with the one or more new communications sessions. The computer-implemented method further comprises facilitating additional communications sessions corresponding to the new topic embeddings.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which a user communications system dynamically identifies a set of topics from an ongoing communications session and segments the ongoing communications session into a set of topic-specific communications sessions based on the identified set of topics in accordance with at least one embodiment;

FIG. 2 shows an illustrative example of an environment in which a topic identification module dynamically processes conversation data corresponding to an ongoing communications session to identify a set of topics from which new topic-specific communications sessions can be facilitated in accordance with at least one embodiment;

FIG. 3 shows an illustrative example of an environment in which a communication segmenting module facilitates new topic-specific communications sessions based on an evaluation of user preferences and cognitive load in accordance with at least one embodiment;

FIGS. 4A and 4B show an illustrative example of an environment in which an ongoing communications session is evaluated in real-time to identify a set of topics being discussed among users and an automated agent and dynamically generating topic-specific communications sessions based on the identified set of topics in accordance with at least one embodiment;

FIG. 5 shows an illustrative example of an environment in which a topic-specific communications session is facilitated in accordance with at least one embodiment;

FIG. 6 shows an illustrative example of a process for identifying a set of topics discussed during an ongoing communications session for facilitating new topic-specific communications sessions in accordance with at least one embodiment;

FIG. 7 shows an illustrative example of a process for generating new topic-specific communications sessions based on a set of identified topics from an ongoing communications session, user preferences, and user cognitive load in accordance with at least one embodiment;

FIGS. 8A-8B show an illustrative example of an environment in which a user communications system dynamically identifies a set of topics from an ongoing communications session associated with multiple users and segments the ongoing communications session into a set of topic-specific communications sessions based on the identified set of topics and according to the users engaged in each of these topics in accordance with at least one embodiment;

FIG. 9 shows an illustrative example of a process for identifying a set of topics discussed during an ongoing communications session and amongst a set of users for facilitating new topic-specific communications sessions according to user engagement in the set of topics in accordance with at least one embodiment;

FIG. 10 shows an illustrative example of an environment in which communications with members are processed in accordance with at least one embodiment; and

FIG. 11 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework for automatically and continuously processing communications exchanges among users and automated agents and corresponding user behaviors to dynamically generate topical communications sessions from ongoing communications sessions. The topical communications sessions are implemented to reduce the cognitive effort of conversation management within existing communications sessions where topical drift may occur. The framework allows users to submit multimedia inputs that are classified by the systems and methods described herein and automatically routed to appropriate communications containers.

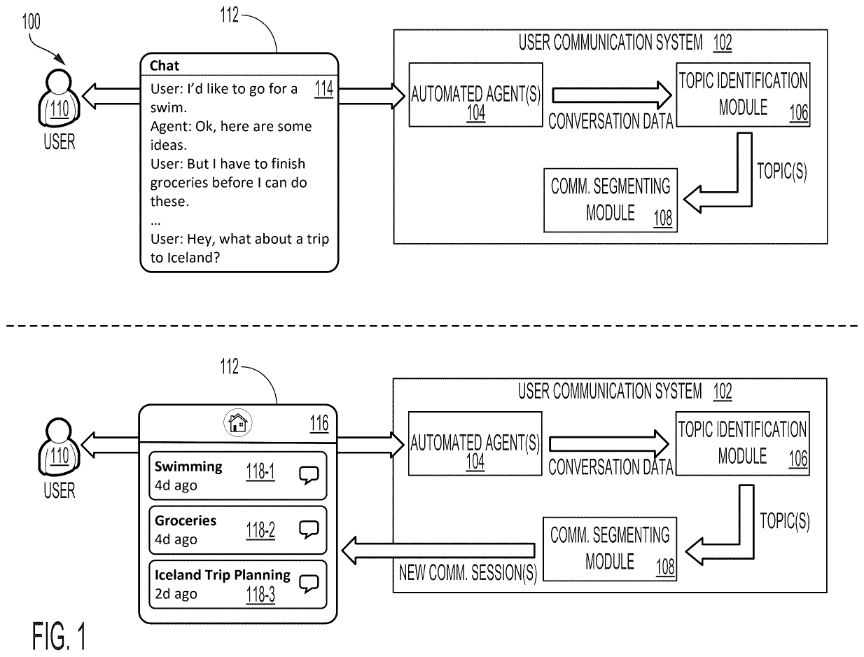

FIG. 1 shows an illustrative example of an environment 100 in which a user communications system 102 dynamically identifies a set of topics from an ongoing communications session 114 and segments the ongoing communications session 114 into a set of topic-specific communications sessions based on the identified set of topics in accordance with at least one embodiment. In the environment 100, a user 110 may be engaged in a communications session 114 with one or more automated agents 104 implemented by a user communications system 102. The user 110 may be engaged in a communications session 114 with one or more automated agents 104 to obtain assistance in performing various tasks, to obtain assistance in achieving different goals, to reduce their and/or their family's cognitive load, and the like.

The user communication system 102 may be implemented to reduce the cognitive load of users and their families by identifying different family goals and generating tasks that may be performed by different family members and/or delegated to other entities (e.g., automated agents 104, human representatives associated with the user communication system 102, third-party services, etc.) for performance on behalf of these users and families. In an embodiment, when a user 110 accesses the user communication system 102 for the first time, the user 110 may be prompted to initiate an onboarding process to obtain identifying information associated with the user 110 and their family that may be used to identify any tasks that may be performed on behalf of the user 110 and their family to achieve any family goals or otherwise reduce the cognitive load of the user 110 and of the family. For instance, the user communication system 102 may prompt the user 110 to provide detailed information with regard to the composition of the user's family (e.g., number of inhabitants in the user's home, the number of children in the user's home, the number and types of pets in the user's home, etc.), the physical location of the user's home, any special needs or requirements of the user 110 (e.g., physical or emotional disabilities, etc.), and the like. In some instances, the user 110 may be prompted to provide demographic information (e.g., age, ethnicity, race, languages written/spoken, etc.). The user 110 may also be prompted to indicate any personal interests or hobbies that may be used to identify possible experiences that may be of interest to the user 110 and/or other family members associated with the user 110. In some instances, the user communication system 102 may prompt the user 110 to specify any tasks that the user 110 would like assistance with or would otherwise like to delegate to another entity, such as an automated agent 104 and/or third-party.

In an embodiment, the automated agent 104 is an automated process, such as a bot, that may be configured to automatically engage and interact with the user 110. For instance, the user communication system 102 may utilize the responses provided by the user 110 during the onboarding process to generate a user profile and an automated agent 104 that may automatically communicate with the user 110 through an ongoing communications session 114. The automated agent 104 may be configured to autonomously chat with the user 110 to generate tasks and proposals, perform tasks on behalf of the user 110 in accordance with any approved proposals, and the like as described herein. The automated agent 104 may be configured according to the parameters or characteristics of the user 110 as defined in the user profile. As the automated agent 104 communicates with the user 110 over time, the automated agent 104 may be updated to improve the automated agent's interaction with the user 110.

In an embodiment, the user communication system 102 provides an application or web service through which users (such as user 110) may access an interface 112 for initiating and engaging in communications sessions with automated agents 104 to address different user intents. For example, the user communication system 102 may provide, to a user 110, an application that may be installed and executed from the user's computing device to access, through the interface 112, the user communication system 102. Additionally, or alternatively, a user 110, through a browser application installed and executed from the user's computing device, may access a website associated with the user communication system 102 and through which the user communication system 102 implements a web service that includes the interface 112. In some instances, to access the interface 112 (either through an application executing on a computing device or through a web service), the user 110 may be required to provide a set of credentials (e.g., username/password, a cryptographic key or token, biometric information, etc.) that may be used to authenticate and identify the user 110. For example, when the user 110 executes the application or accesses the web service to initiate a new communications session 114 through the user communication system 102, the user communication system 102 may prompt the user 110 to provide a set of credentials associated with the user 110.

In response to receiving the set of credentials associated with the user 110, the user communication system 102 may process the set of credentials to determine whether the set of credentials are valid. For instance, in response to receiving a set of credentials from a user 110, the user communication system 102 may query a user profile database to determine whether the provided set of credentials is associated with an existing user profile maintained by the user communication system 102. If the user communication system 102 determines that the provided set of credentials is not associated with an existing user profile, or that the provided set of credentials is not valid (e.g., the set of credentials does not match a known set of credentials maintained in an identified user profile, the set of credentials is expired, the set of credentials are flagged as being compromised, etc.), the user communication system 102 may reject the request from the user 110 to initiate a communications session 114 with an automated agent 104. If the user communication system 102 determines that the set of credentials is valid or otherwise that the user 110 has been successfully authenticated, the user communication system 102 may establish a new communications session between the user 110 and an automated agent 104.

The initial communications session 114 between a user 110 and an automated agent 104 may be centered around a particular topic. For example, when the user 110 initiates the communications session 114 with an automated agent 104, the user 110 may discuss a particular goal that the user 110 would like assistance with so that the user 110 may achieve the particular goal. As another example, the user 110 may initially discuss a particular task around their home that they and one or more family members would assistance with for completion. However, over time, this initial communications session 114 may experience topical drift, whereby the topics of conversation between the user 110 and the automated agent 104 may change over time. This may make it difficult to return to previous topics, as the user 110 may be unable to quickly identify from the initial communications session 114 any previously exchanged communications related to these previous topics without significant effort. As illustrated in FIG. 1, the user 110, through the initial communications session 114 has indicated that they would like to go for a swim, after which the automated agent 104 may provide the user 110 with various ideas for completing this swim. Subsequently, the user 110 may express that they have to complete their grocery shopping before they are able to partake in a swim. This conversation flow may result in a topical drift from the user's desire to go swimming to the need to complete their grocery shopping. Further, as illustrated in FIG. 1, the communications session 114 may further drift towards a completely unrelated topic, namely a conversation with one or more other users and the automated agent 104 regarding a trip to Iceland. As the communications session 114 shifts towards a discussion relation to this trip to Iceland, any communications previously exchanged regard the desire for a swim and the user's need to complete their groceries may be buried, making it difficult for the user 110 to return to these older topics through the communications session 114.

In an embodiment, to address this issue of topical drift, the user communication system 102 implements a topic identification module 106 that is configured to dynamically identify different topics expressed during the communications session 114. The topic identification module 106 may be implemented as an application or process executing on a computer system of the user communication system 102. In some instances, the topic identification module 106 may be configured with various special-purpose components that can facilitate real-time or near real-time processing of different communications or messages from any number of different users as these different communications or messages are received. In an embodiment, the topic identification module 106 monitors ongoing communications sessions, such as communications session 114, to obtain in real-time or near real-time any communications exchanged between different users and automated agents 104. Further, the topic identification module 106 may continuously process historical communications previously exchanged between different users and automated agents 104 to dynamically identify any topical shifts and to determine the context of these topical shifts. As described in greater detail herein, this may allow the topic identification module 106 to better identify the various topics discussed between different users and automated agents 104.

In an embodiment, the topic identification module 106 implements natural language processing (NLP) or any other language parsing algorithm or executable code to automatically parse the communications exchanged between the user 110 and an automated agent 104. Through NLP or other language parsing algorithm or executable code, the topic identification module 106 may dynamically convert these exchanged communications into a set of embeddings corresponding to these exchanged communications. In some instances, the topic identification module 106 may further process historical communications exchanged between the user 110 and the automated agent 104 to obtain additional contextual information that may used to supplement the newly obtained exchanged communications and refine the set of embeddings corresponding to these exchanged communications. For example, if a newly exchanged communication indicates a user's acknowledgment of a previously identified task that is to be performed by the automated agent 104, the topic identification module 106 may process historical communications associated with communications session 114 to dynamically identify any previously exchanged communications related to this previously identified task.

In an embodiment, the topic identification module 106 dynamically trains and implements one or more large language models (LLMs) and/or other generative artificial intelligence processes to evaluate the set of embeddings to identify different topics expressed during ongoing communications sessions. For instance, the topic identification module 106 may maintain a known topics datastore or other datastore that may serve as a knowledge base corresponding to different topics that may be discussed between users and automated agents 104 of the user communication system 102. These different topics may be identified over time as different users communicate with different automated agents for the completion of tasks, for the accomplishment of goals, and for any other purpose expressed by these different users. In some instances, these different topics may be further identified using a corpus of internal and external (e.g., third-party) sample communications corresponding to different topics that may be communicated amongst different users and representatives (e.g., automated agents, human agents, etc.).

In an embodiment, the topic identification module 106, through this known topics datastore or other datastore, maintains different embeddings corresponding to different topics that may be associated with different communications. For instance, for different communications known to correspond to different topics, the topic identification module 106 may convert these different communications into different sets of embeddings that may be used to dynamically identify different topics associated with received communications exchanged between users and automated agents 104. As this corpus of communications corresponding to known topics may be obtained from myriad data sources (e.g., from historical conversations maintained by the user communication system 102, from sample communications provided by third-party entities, from sample communications provided by an administrator of the user communication system 102, etc.), the topic identification module 106 may be implemented using thousands, tens of thousands, or mote processes that are configured to operate in parallel to process these available communications and generate corresponding embeddings.

The one or more LLMs and/or other generative artificial intelligence processes implemented by the topic identification module 106 are, in an embodiment, dynamically trained using a dataset comprising a large corpus of sample communications/messages (e.g., historical communications/messages, hypothetical communications/messages, combinations of historical and hypothetical communications/messages, etc.), sample embeddings corresponding to the sample communications/messages, and sample topics corresponding to the sample communications/messages (e.g., historical topics, hypothetical topics, combinations of historical and hypothetical topics, etc.). The one or more LLMs and/or other generative artificial intelligence processes may be initialized with a first set of values corresponding to different hyperparameters or other coefficients that, in combination, are used to derive an output given a sample input (e.g., sample communications/messages). For instance, the topic identification module 106 may initialize a set of coefficients or other hyperparameters randomly according to a Gaussian distribution with low variance centered around zero. Using this initial iteration of the one or more LLMs or other generative artificial intelligence processes, the topic identification module 106 may process the dataset of sample communications/messages to generate an output. This output may specify, for each sample communication or message, a topic corresponding to the communication or message. The one or more LLMs or other generative artificial intelligence processes may compare the output (e.g., predicted topics) to the expected topics included in the dataset. Based on this comparison, the one or more LLMs or other generative artificial intelligence processes may dynamically update the values corresponding to the different hyperparameters or other coefficients and again process the dataset to generate new outputs. This process may be repeated numerous times until an iteration of the one or more LLMs or other generative artificial intelligence processes is obtained that satisfies one or more accuracy or predictability thresholds.

In an embodiment, the one or more LLMs or other generative artificial intelligence processes are further trained in conjunction with retrieval-augmented generation (RAG) to improve the predictability of the one or more LLMs or other generative artificial intelligence processes in identifying topics that accurately reflect the communications exchanged between users and automated agents 104 during ongoing communications sessions. For instance, in addition to evaluating the one or more LLMs or other generative artificial intelligence processes according to linguistic metrics (e.g., Bilingual Evaluation Understudy (BLEU) scores, language fluency metrics, semantic consistency metrics, etc.), the topic identification module 106 may determine whether the one or more LLMs or other generative artificial intelligence processes are accurately leveraging the available known topics datastore or other datastores to generate outputs (e.g., topics) that are expressed in the sample communications/messages. For instance, the topic identification module 106 may evaluate the output generated by the one or more LLMs or other generative artificial intelligence processes to determine whether the one or more LLMs or other generative artificial intelligence processes are correctly converting the sample communications/messages into a set of embeddings and identifying appropriate topics according to this set of embeddings (e.g., correctly matching the set of embeddings to topic embeddings corresponding to known topics that may be addressed through the user communication system 102, etc.). Based on this evaluation, the topic identification module 106 may dynamically update the one or more LLMs or other generative artificial intelligence processes as described above to improve the accuracy of these one or more LLMs or other generative artificial intelligence processes in identifying the relevant topics being discussed during ongoing communications sessions.

In response to a communication or message exchanged by the user 110 through the ongoing communications session 114, the topic identification module 106, through the one or more LLMs or other generative artificial intelligence processes, may dynamically identify a topic that is derived from the known topics datastore or other datastores maintained by the topic identification module 106. In an embodiment, as the topic identification module 106 identifies different topics associated with the ongoing communications session 114, the topic identification module 106 transmits these identified topics and the conversation data corresponding to the ongoing communications session 114 (e.g., the exchanged communications and any available historical communications exchanged between the user 110 and the automated agent 104) to a communication segmenting module 108 to generate and facilitate topic-specific communications sessions associated with these identified topics. The communication segmenting module 108 may be implemented using a computer system or as an application or other executable code implemented on a computer system of the user communication system 102.

In an embodiment, the communication segmenting module 108 is implemented to dynamically decompose ongoing communications sessions into topic-specific communications sessions according to the different topics identified from the ongoing communications sessions, user preferences, and user cognitive loads. In response to receiving, from the topic identification module 106, a set of identified topics corresponding to communications exchanged between a user 110 and an automated agent 104 through the ongoing communications session 114 and conversation data corresponding to this ongoing communications session 114, the communication segmenting module 108 may query a user profile datastore to identify a user profile corresponding to the user 110. A user profile may define a set of attributes of the user 110 that may be used by the user communication system 102 (such as through an automated agent 104) to determine how best to approach the user 110 in conversation, in recommending tasks and proposals to the user 110, and in performance of the tasks for the benefit of the user 110 and/or the user's family. These attributes may include a measure of user behavior or preference in delegating certain categories of tasks to others or in performing certain categories of tasks themselves. For instance, a user attribute may provide a score or other metric corresponding to the probability of the user 110 delegating different categories of tasks to others to perform. As another example, a user attribute may provide an indication of a user's preference to be presented with proposals for completion of a task (if being delegated) or to simply allow another to decide for the user 110. Other member attributes may indicate whether the user 110 is concerned with budgets, with brand recognition, with reviews (e.g., restaurant reviews, product reviews, etc.), with punctuality, with speed of response, and the like. User attributes may further include basic information about the user 110 as provided during the onboarding process described above.

In some instances, the user communication system 102 allows the user 110 to access their user profile to provide additional information that may be used to supplement the user profile and/or to modify any previously added information. For example, through an application or web portal provided by the user communication system 102, the user 110 may be provided with a link or other interactive element that may be used by the user 110 to access their user profile. Within the user profile, the user 110 may add, remove, or edit any information within the user profile. The user profile may be divided into various sections corresponding to different user characteristics, such as personal demographics, family composition, home composition, payment information, and the like. The user communication system 102 may automatically populate elements of these various sections based on the user's previously provided responses to the prompts provided by the user communication system 102 during the onboarding process, as well as any responses provided by the user 110 to surveys or questionnaires provided to the user 110 during the onboarding process. Each section of the user profile may further include additional questions or prompts that the user 110 may use to provide additional information that may be used to expand the user profile.

In an embodiment, the communication segmenting module 108 can process the user profile associated with the user 110 to determine the user's cognitive load. For instance, the communication segmenting module 108 may use the user profile, corresponding tasks associated with the user 110, and the conversation data corresponding to the ongoing communications session 114 as input to a machine learning algorithm or artificial intelligence to generate a cognitive load score for the user 110. The machine learning algorithm or artificial intelligence may be dynamically trained using a dataset of sample user profiles (e.g., actual user profiles corresponding to actual users, hypothetical user profiles corresponding to hypothetical users, combinations of actual and hypothetical user profiles, etc.), corresponding sample tasks, sample communications (e.g., historical communications associated with actual users, hypothetical communications associated with hypothetical users, combinations of historical and hypothetical communications, etc.) and sample cognitive load scores corresponding to the aforementioned inputs.

To dynamically train this machine learning algorithm or artificial intelligence to determine the cognitive load of different users, the communication segmenting module 108 may generate an initial iteration of the machine learning algorithm or artificial intelligence. For instance, the communication segmenting module 108 may initialize a set of coefficients or hyperparameters randomly according to a Gaussian distribution with low variance centered around zero. Using this initial iteration of the machine learning algorithm or artificial intelligence, the communication segmenting module 108 may process the aforementioned dataset to generate an output. This output may specify, for each sample user profile and corresponding conversation data included in the dataset, a predicted cognitive load score. The communication segmenting module 108 may compare the predicted set of cognitive load scores generated using the initial iteration of the machine learning algorithm or artificial intelligence to the sample cognitive load scores defined in the dataset for each of the data points (e.g., sample user profiles) to identify any inaccuracies or other errors.

If the output of the machine learning algorithm or artificial intelligence does not satisfy one or more criteria, the communication segmenting module 108 may iteratively update one or more coefficients of the set of coefficients to generate a new iteration of the machine learning algorithm or artificial intelligence. This new iteration of the machine learning algorithm or artificial intelligence may be used to process the aforementioned training dataset, as well as any additional data points or other datasets obtained by the user communication system 102 to generate a new output for each data point in the training dataset. In some instances, the communication segmenting module 108 may use an optimization algorithm to iteratively update the one or more coefficients of the set of coefficients associated with the machine learning algorithm or artificial intelligence. The communication segmenting module 108 may use this new iteration of the machine learning algorithm or artificial intelligence to process the available data points and generate a new output. The communication segmenting module 108 may evaluate this new output to determine whether the output satisfies the one or more criteria. This process of updating the set of coefficients associated with the machine learning algorithm or artificial intelligence according to the one or more criteria may be performed iteratively until an iteration of the machine learning algorithm or artificial intelligence is produced that satisfies the one or more criteria.

Once the machine learning algorithm or artificial intelligence is dynamically trained to calculate the cognitive load score of different users, the machine learning algorithm or artificial intelligence may process the user profile associated with the user 110 and the conversation data corresponding to the ongoing communications session 114 to calculate a cognitive load score associated with the user 110. The cognitive load score associated with the user 110 may be used to determine the number of distinct topics that may be presented to the user 110 from the ongoing communications session 114. As an illustrative example, if the user 110 is assigned a high cognitive load score (i.e., the user 110 is exhibiting high levels of stress), the communication segmenting module 108 may determine that the user 110 should be presented with a limited number of different topics to not overburden or overwhelm the user 110 with myriad topics extracted from the ongoing communications session 114. Additionally, based on this identified number of topics that may be presented to the user 110, the communication segmenting module 108 may rank the set of topics provided by the topic identification module 106 to identify the topics that may be presented to the user 110. For instance, based on the cognitive load score associated with the user 110, the communication segmenting module 108 may rank these topics based on the level of urgency for addressing these topics. The level of urgency may be determined based on user characteristics from the user profile (e.g., data corresponding to a user's own prioritization of certain topics) and/or potential risks to the user 110 if certain topics are not addressed. The communication segmenting module 108 may further rank these topics based on the amount of cognitive load that may be reduced through addressing each of these topics. For instance, if addressing a particular topic may greatly reduce the user's cognitive load, this topic may be assigned a higher rank compared to another topic that, if addressed, would not have such an impact on the user's cognitive load.

In an embodiment, the communication segmenting module 108 automatically generates new topic-specific communications sessions corresponding to each selected topic from the set of topics indicated by the topic identification module 106. In some instances, for each new topic-specific communications session, the communication segmenting module 108 may implement a new automated agent 104 that may communicate with the user 110 with regard to the topic associated with the topic-specific communications session. Alternatively, the new topic-specific communications sessions may be facilitated using the same automated agent 104 used for the ongoing communications session 114.

As illustrated in FIG. 1, when the new topic-specific communications sessions are initiated by the communication segmenting module 108, the communication segmenting module 108 may dynamically update the interface 112 to provide, through a communications session window 116, a set of topic-specific communications session tabs 118-1-118-3 through which the user 110 may access the topic-specific communications session to review previous communications associated with these topics and engage an automated agent 104 with regard to these topics. For example, as illustrated in FIG. 1, the communication segmenting module 108 has created topic-specific communications session tabs 118-1-118-3 corresponding to a swimming topic, a groceries topic, and an Iceland trip planning topic, respectively. These topics may correspond to the different topics of conversation included in the original communications session 114 between the user 110 and the automated agent 104.

If the user 110 selects a particular topic-specific communications session tab from the communications session window 116, the user communication system 102 may update the interface 112 to present the topic-specific communications session associated with the selected topic. The user 110, through this topic-specific communications session, may communicate with an automated agent 104 to address the particular topic and review any previous communications exchanged through the original communications session 114 to obtain contextual information that may assist the user 110 in recalling any previously provided information with regard to this topic. Thus, the user 110 may no longer be required to parse through myriad communications exchanged through the original communications session 114 to identify any specific communications related to this topic, thereby reducing the user's cognitive load and reducing the amount of time required to recall any elements of the particular topic.

In an embodiment, the communication segmenting module 108 further generates and presents a summary of each topic-specific communications session generated from the original communications session 114. This summary may be presented to inform the user 110 of the particular topic associated with the topic-specific communications session and of the context of the communications previously exchanged related to this topic. To generate this summary, the communication segmenting module 108 may process the conversation data associated with this topic through one or more LLMs or other generative artificial intelligence process that are trained to perform an extractive, abstractive, or hybrid summarization of this conversation data related to the particular topic. For instance, the one or more LLMs or other generative artificial intelligence process may dynamically evaluate the various communications associated with the particular topic and extract any terms and/or phrases that may be used to construct a summary of the communications related to the topic. As another illustrative example, the one or more LLMs or other generative artificial intelligence process may process the communications associated with the topic and generate a summary based on an evaluation of these communications. This summary may be evaluated according to linguistic metrics (e.g., Bilingual Evaluation Understudy (BLEU) scores, language fluency metrics, semantic consistency metrics, etc.) to ensure that the summary is likely to be understood by the user 110.

In an embodiment, the topic identification module 106 continuously monitors communications exchanged through the topic-specific communications sessions to dynamically detect any topic drift and, accordingly, identify any new topics being discussed within these topic-specific communications sessions. If the topic identification module 106 identifies one or more new topics being discussed within an ongoing topic-specific communications session, the topic identification module 106 may provide the conversation data corresponding to this topic-specific communications session and the newly identified topics to the communication segmenting module 108 to determine whether new topic-specific communications sessions may be facilitated for these newly identified topics. Thus, through this continuous and real-time monitoring of different communications sessions, the user communication system 102 may continuously ensure that no communications session becomes cluttered with communications related to myriad topics. Further, through this continuous and real-time monitoring of different communications sessions, the user communication system 102 may provide users with relevant and topic-specific information, thereby reducing the amount of effort required by the user 110 to identify communications related to these topics and more quickly address any tasks or issues related to these topics.

Further, the topic identification module 106 may continuously monitor these communications to determine whether any communications correspond to existing topics for which other topic-specific communications sessions were established. In the event that the topic identification module 106 determines that one or more communications being exchanged in a particular topic-specific communications session correspond to a different existing topic for which another topic-specific communications session is implemented, the topic identification module 106 may automatically, and dynamically, transfer these communications to this other topic-specific communications session and inform the user 110 of this transfer. This may allow the user 110 to revert to the other topic-specific communications session to continue a conversation related to the other topic. Further, this may ensure that each topic-specific communications session remains specific to the particular topic.

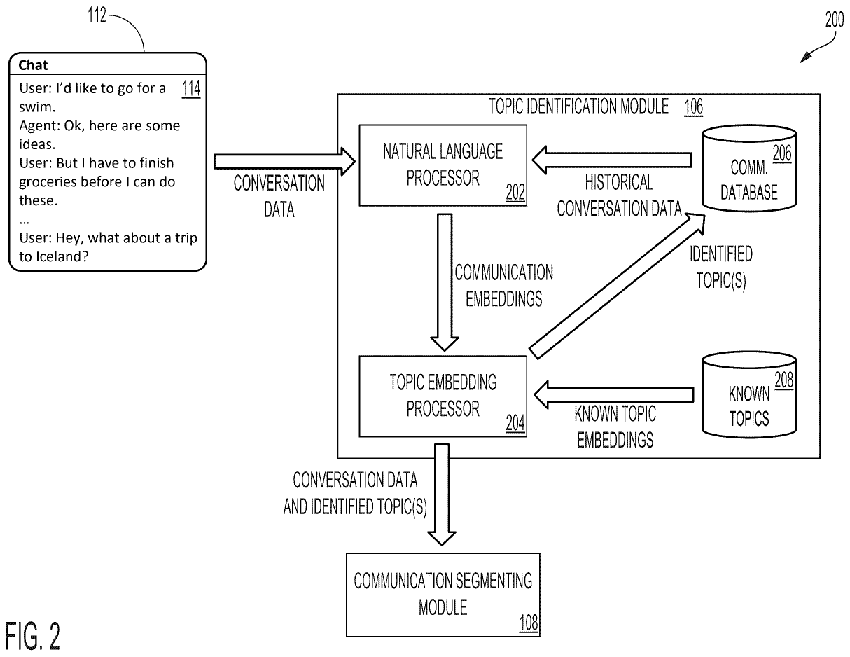

FIG. 2 shows an illustrative example of an environment 200 in which a topic identification module 106 dynamically processes conversation data corresponding to an ongoing communications session 114 to identify a set of topics from which new topic-specific communications sessions can be facilitated in accordance with at least one embodiment. In the environment 200, the topic identification module 106 continuously and in real-time or near real-time obtains conversation data corresponding to different communications exchanged between a user and an automated agent through an ongoing communications session 114. As noted above, this ongoing communications session 114 may be facilitated through an interface 112 provided by the user communication system, such as through an application executing on a user's computing device or through a web service provided by the user communication system.

In an embodiment, the topic identification module implements a natural language processor 202 that is configured to perform NLP or any other language parsing on received conversation data to convert the conversation data into a set of communication embeddings. As illustrated in FIG. 2, the natural language processor 202 may further obtain from a communications database 206, historical conversation data corresponding to the ongoing communications session 114 to obtain any previously exchanged communications and any previously identified topics associated with the ongoing communications session 114. The natural language processor 202 may use the historical conversation data corresponding to the ongoing communications session 114 and the previously identified topics to determine the context of the newly obtained conversation data and, based on this context, refine the set of communication embeddings corresponding to the conversation data.

The natural language processor 202, in an embodiment, is a machine learning algorithm or artificial intelligence that is dynamically trained to process conversation data obtained through ongoing communications sessions (such as ongoing communications session 114) to convert the conversation data into sets of communication embeddings. The natural language processor 202 may be dynamically trained using a dataset of sample communications (e.g., historical communications, hypothetical communications, combinations of historical and hypothetical communications, etc.) and sample embeddings corresponding to the sample communications. To dynamically train the natural language processor 202, the topic identification module 106 may generate an initial iteration of the natural language processor 202. For instance, the topic identification module 106 may initialize a set of coefficients or hyperparameters randomly according to a Gaussian distribution with low variance centered around zero. Using this initial iteration of the natural language processor 202, the topic identification module 106 may process the dataset of sample communications and corresponding embeddings to generate an output. This output may specify, for each sample communication included in the dataset, a predicted set of communication embeddings. The topic identification module 106 may compare the predicted set of communication embeddings generated using the initial iteration of the natural language processor 202 to the sample communication embeddings defined in the dataset for each of the data points (e.g., sample communications) to identify any inaccuracies or other errors.

If the output of the natural language processor 202 does not satisfy one or more criteria, the topic identification module 106 may iteratively update one or more coefficients of the set of coefficients to generate a new iteration of the natural language processor 202. This new iteration of the natural language processor 202 may be used to process the aforementioned training dataset, as well as any additional data points or other datasets obtained by the user communication system to generate a new output for each data point in the training dataset. In some instances, the topic identification module 106 may use an optimization algorithm to iteratively update the one or more coefficients of the set of coefficients associated with the natural language processor 202. The topic identification module 106 may use this new iteration of the natural language processor 202 to process the available data points and generate a new output. The topic identification module 106 may evaluate this new output to determine whether the output satisfies the one or more criteria. This process of updating the set of coefficients associated with the natural language processor 202 according to the one or more criteria may be performed iteratively until an iteration of the natural language processor 202 is produced that satisfies the one or more criteria.

Once the natural language processor 202 is dynamically trained to convert conversation data into different sets of embeddings, the natural language processor 202 may process the received conversation data from the ongoing communications session 114 and the historical conversation data from the communications database 206 into a particular set of communication embeddings corresponding to the obtained conversation data. The natural language processor 202 may transmit this set of communication embeddings to a topic embedding processor 204 of the topic identification module 106 to identify a set of topics associated with the ongoing communications session 114.

The topic embedding processor 204, in an embodiment, implements a machine learning algorithm or artificial intelligence that is dynamically trained to compare received sets of communication embeddings (as generated by the natural language processor 202 through processing of conversation data) to embeddings corresponding to known topics, as described above in connection with FIG. 1. The topic embeddings corresponding to known topics may be maintained in a known topics datastore 208. These known topics may be generated by the user communication system or other entity associated with the user communication system based on different available sources. For instance, the user communication system may evaluate historical conversation data corresponding to prior communications sessions between different users and automated agents to identify any topics associated with these prior communications sessions. The user communication system may annotate these prior communications sessions and generate topic embeddings corresponding to the communications associated with these topics. Further, the user communication system may process feedback from different users corresponding to different topics discussed during communications sessions with different automated agents. This feedback may include indications of automated agent performance in identifying ongoing topics during communications sessions and in providing relevant responses to user communications. Thus, the user communications system may further annotate this feedback and corresponding communications to generate topic embeddings corresponding to these communications.

Through the machine learning algorithm or artificial intelligence, the topic embedding processor 204 may perform clustering or classification of different communication embeddings in real-time or near real-time as these communication embeddings are obtained from the natural language processor 202. Through this processing of the different communication embeddings from the natural language processor 202, the topic embedding processor 204 may obtain partial matches among different known topic embeddings from the known topics datastore 208 to identify the topics associated with the ongoing communications session. In an embodiment, as the topic embedding processor 204 identifies different topics associated with the ongoing communications session 114, the topic embedding processor 204 transmits these identified topics and the conversation data corresponding to the ongoing communications session 114 (e.g., the exchanged communications and any available historical communications associated with the ongoing communications session 114) to the communication segmenting module 108 to generate and facilitate topic-specific communications sessions associated with these identified topics. Additionally, the topic embedding processor 204 may update the communication database 206 to indicate, for the ongoing communications session 114, the one or more newly identified topics. This may allow the natural language processor 202 to determine the context of new conversation data as the new conversation data is received and as described above.

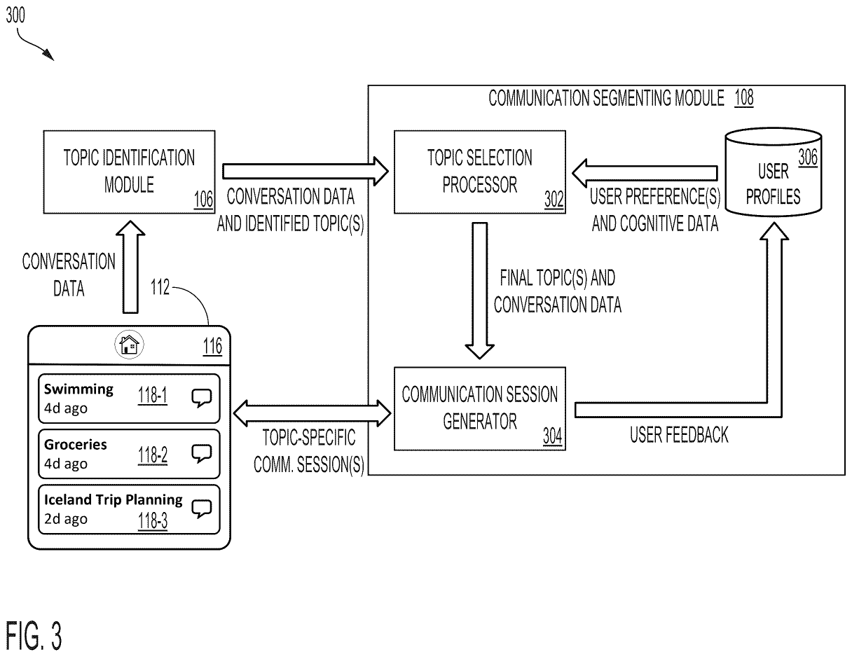

FIG. 3 shows an illustrative example of an environment in which a communication segmenting module 108 facilitates new topic-specific communications sessions based on an evaluation of user preferences and cognitive load in accordance with at least one embodiment. In the environment 300, the communication segmenting module 108 may obtain, from the topic identification module 106, conversation data corresponding to an ongoing communications session between a user and an automated agent. In addition to this conversation data, the communication segmenting module 108 may receive a set of identified topics associated with the ongoing communications session and identified by the topic identification module 106, through the natural language processor 202 and the topic embedding processor 204 described above in connection with FIG. 2. In an embodiment, this conversation data and corresponding topics associated with the ongoing communications session may be received by a topic selection processor 302 implemented by the communication segmenting module 108. The topic selection processor 302 may be implemented using a computer system or as an application or other executable code implemented on a computer system of the communication segmenting module 108.

In an embodiment, in response to receiving conversation data associated with an ongoing communications session and a set of topics identified by the topic identification module 106 based on an evaluation of exchanged communications, the topic selection processor 302 queries a user profile datastore 306 to identify user profiles corresponding to the users engaged in the ongoing communications session. As noted above, a user profile from the user profile datastore 306 may define a set of attributes of the corresponding user that may be used by the user communication system (such as through an automated agent) to determine how best to approach the user in conversation, in recommending tasks and proposals to the user, and in performance of the tasks for the benefit of the user and/or the user's family. These attributes may include a measure of user behavior or preference in delegating certain categories of tasks to others or in performing certain categories of tasks themselves. For instance, a user attribute may provide a score or other metric corresponding to the probability of the user delegating different categories of tasks to others to perform. As another example, a user attribute may provide an indication of a user's preference to be presented with proposals for completion of a task (if being delegated) or to simply allow another to decide for the user. Other member attributes may indicate whether the user is concerned with budgets, with brand recognition, with reviews (e.g., restaurant reviews, product reviews, etc.), with punctuality, with speed of response, and the like. User attributes may further include basic information about the user as provided during an onboarding process.

As noted above, user profiles may be accessible to corresponding users to allow these users to provide additional information that may be used to supplement or otherwise modify these user profiles. Returning to an earlier illustrative example, through an application or web portal provided by the user communication system, a user may be provided with a link or other interactive element that may be used by the user to access their user profile. Within the user profile, the user may add, remove, or edit any information within the user profile. The user profile may be divided into various sections corresponding to different user characteristics, such as personal demographics, family composition, home composition, payment information, and the like. The user communication system may automatically populate elements of these various sections based on the user's previously provided responses to the prompts provided by the user communication system during the onboarding process, as well as any responses provided by the user to surveys or questionnaires provided to the user during the onboarding process. Each section of the user profile may further include additional questions or prompts that the user may use to provide additional information that may be used to expand the user profile.

In an embodiment, the topic selection processor 302 dynamically processes the user profiles corresponding to the users engaged in the ongoing communications session and the received conversation data to determine the cognitive load of each of these users. For instance, the topic selection processor 302 may use these user profiles, corresponding tasks associated with the users engaged in the communications session, and the conversation data corresponding to the ongoing communications session as input to a trained machine learning algorithm or artificial intelligence to generate a cognitive load score for each of these users. The machine learning algorithm or artificial intelligence may be dynamically trained using a dataset of sample user profiles (e.g., actual user profiles corresponding to actual users, hypothetical user profiles corresponding to hypothetical users, combinations of actual and hypothetical user profiles, etc.), corresponding sample tasks, sample communications (e.g., historical communications associated with actual users, hypothetical communications associated with hypothetical users, combinations of historical and hypothetical communications, etc.) and sample cognitive load scores corresponding to the aforementioned inputs.

To dynamically train this machine learning algorithm or artificial intelligence to determine the cognitive load of different users, the topic selection processor 302 may generate an initial iteration of the machine learning algorithm or artificial intelligence. For instance, the topic selection processor 302 may initialize a set of coefficients or hyperparameters randomly according to a Gaussian distribution with low variance centered around zero. Using this initial iteration of the machine learning algorithm or artificial intelligence, topic selection processor 302 may process the aforementioned dataset to generate an output. This output may specify, for each sample user profile and corresponding conversation data included in the dataset, a predicted cognitive load score. The topic selection processor 302 may compare the predicted set of cognitive load scores generated using the initial iteration of the machine learning algorithm or artificial intelligence to the sample cognitive load scores defined in the dataset for each of the data points (e.g., sample user profiles) to identify any inaccuracies or other errors.

If the output of the machine learning algorithm or artificial intelligence does not satisfy one or more criteria, the topic selection processor 302 may iteratively update one or more coefficients of the set of coefficients to generate a new iteration of the machine learning algorithm or artificial intelligence. This new iteration of the machine learning algorithm or artificial intelligence may be used to process the aforementioned training dataset, as well as any additional data points or other datasets obtained by the user communication system to generate a new output for each data point in the training dataset. In some instances, the topic selection processor 302 may use an optimization algorithm to iteratively update the one or more coefficients of the set of coefficients associated with the machine learning algorithm or artificial intelligence. The topic selection processor 302 may use this new iteration of the machine learning algorithm or artificial intelligence to process the available data points and generate a new output. The topic selection processor 302 may evaluate this new output to determine whether the output satisfies the one or more criteria. This process of updating the set of coefficients associated with the machine learning algorithm or artificial intelligence according to the one or more criteria may be performed iteratively until an iteration of the machine learning algorithm or artificial intelligence is produced that satisfies the one or more criteria.

Once the machine learning algorithm or artificial intelligence is dynamically trained to calculate the cognitive load scores of different users, the machine learning algorithm or artificial intelligence may process the user profiles corresponding to the users engaged in the ongoing communications session and the conversation data obtained from the topic identification module 106 to calculate a cognitive load score for each user engaged in the ongoing communications session. As noted above, a cognitive load score associated with a user may be used to determine the number of distinct topics that may be presented to the user from the ongoing communications session. Returning to an earlier illustrative example, if a user is assigned a high cognitive load score (i.e., the user is exhibiting high levels of stress), the topic selection processor 302 may determine that the user should be presented with a limited number of different topics to not overburden or overwhelm the user with myriad topics extracted from the ongoing communications session. Additionally, based on this identified number of topics that may be presented to the user, the topic selection processor 302 may rank the set of topics provided by the topic identification module 106 to identify the topics that may be presented to the user. For instance, based on the cognitive load score associated with the user, the topic selection processor 302 may rank these topics based on the level of urgency for addressing these topics. The level of urgency may be determined based on user characteristics from the user profile (e.g., data corresponding to a user's own prioritization of certain topics) and/or potential risks to the user if certain topics are not addressed. The topic selection processor 302 may further rank these topics based on the amount of cognitive load that may be reduced through addressing each of these topics. For instance, if addressing a particular topic may greatly reduce the user's cognitive load, this topic may be assigned a higher rank compared to another topic that, if addressed, would not have such an impact on the user's cognitive load.

Once the topic selection processor 302 has selected, for each user engaged in an ongoing communications session, one or more topics that may be presented to the user based on their current level of cognitive load and user preferences as determined from their user profile, the topic selection processor 302 may provide these one or more topics and the conversation data corresponding to the original ongoing communications session to a communication session generator 304. The communication session generator 304 may be implemented using a computer system or as an application or other executable code implemented on a computer system of the communication segmenting module 108. In an embodiment, the communication session generator 304 automatically generates new topic-specific communications sessions corresponding to each topic selected by the topic selection processor 302. In some instances, for each new topic-specific communications session, the communication session generator 304 may implement a new automated agent that may communicate with a corresponding user with regard to the topic associated with the topic-specific communications session. Alternatively, the new topic-specific communications sessions may be facilitated using the same automated agent used for the original ongoing communications session.

As illustrated in FIG. 3, when the new topic-specific communications sessions are initiated by the communication session generator 304, the communication session generator 304 may dynamically update the interface 112 to provide, through a communications session window 116, a set of topic-specific communications session tabs 118-1-118-3 through which a user may access any of these topic-specific communications sessions to review previous communications associated with these topics and engage an automated agent with regard to these topics. For example, as illustrated in FIG. 3, the communication session generator 304 has created topic-specific communications session tabs 118-1-118-3 corresponding to a swimming topic, a groceries topic, and an Iceland trip planning topic, respectively. These topics may correspond to the different topics of conversation included in the original communications session between the user and the automated agent. As the original ongoing communications session may involve any number of users, the topic selection processor 302 may select different topics for these users based on their unique user preferences and their cognitive loads. Accordingly, for an ongoing communications session, the communication session generator 304 may generate different topic-specific communications sessions for these different users according to the topics selected by the topic selection processor 302 for these users.

As noted above, if a user selects a particular topic-specific communications session tab from the communications session window 116, the user communication system may update the interface 112 to present the topic-specific communications session associated with the selected topic. The user, through this topic-specific communications session, may communicate with an automated agent to address the particular topic and review any previous communications exchanged through the original communications session to obtain contextual information that may assist the user in recalling any previously provided information with regard to this topic. Thus, the user may no longer be required to parse through myriad communications exchanged through the original communications session to identify any specific communications related to this topic, thereby reducing the user's cognitive load and reducing the amount of time required to recall any elements of the particular topic.

In an embodiment, the communication session generator 304 implements one or more LLMs or other generative artificial intelligence processes that are trained to generate a summary of each topic-specific communications session generated from the original ongoing communications session. This summary may be presented to inform the user of the particular topic associated with the topic-specific communications session and of the context of the communications previously exchanged through the original ongoing communications session and related to this topic. The communication session generator 304 may use, as input, the conversation data associated with the ongoing communications session and the topics selected by the topic selection processor 302 to generate summaries corresponding to the topic-specific communications sessions associated with these selected topics. As noted above, the one or more LLMs or other generative artificial intelligence processes may be trained to perform an extractive, abstractive, or hybrid summarization of this conversation data related to each particular topic. For instance, the one or more LLMs or other generative artificial intelligence process may dynamically evaluate the various communications associated with a particular topic and extract any terms and/or phrases that may be used to construct a summary of the communications related to the topic. As another illustrative example, the one or more LLMs or other generative artificial intelligence process may process the communications associated with the topic and generate a summary based on an evaluation of these communications. This summary may be evaluated according to linguistic metrics (e.g., BLEU scores, language fluency metrics, semantic consistency metrics, etc.) to ensure that the summary is likely to be understood by a recipient user.

In some instances, the communication session generator 304 may dynamically monitor user interactions with newly generated topic-specific communications sessions to obtain feedback that may be used to update a user's existing user profile. For example, if a user expresses, in a topic-specific communications session, that the user is not interested in the particular topic or that the user would like to prioritize a different topic expressed during the original ongoing communications session, the communication session generator 304 may revise the user profile corresponding to this user to indicate that the user did not receive this selected topic favorably and that a different topic should have been selected from the ongoing communications session for this user. This update to the user profile may be used to update the dataset used by the topic selection processor 302 to train the machine learning algorithm or artificial intelligence implemented to select different topics for different users and that may be used to facilitate topic-specific communications sessions. For example, a new data point may be added to the dataset that incorporates the conversation data from the ongoing communications session, the original topics selected for the user, and an annotation highlighting the feedback provided by the user for these original topics. Accordingly, the topic selection processor 302 may process this updated dataset through the machine learning algorithm or artificial intelligence and make any revisions to the machine learning algorithm or artificial intelligence based on an evaluation of sample outputs generated from this updated dataset. Thus, based on feedback provided by users with regard to newly generated topic-specific communications sessions, the topic selection processor 302 may continuously update and refine the machine learning algorithm or artificial intelligence to provide improved topic selections for different users.

As noted above, and as illustrated in FIG. 3, the topic identification module 106 may continuously monitor communications exchanged through the topic-specific communications sessions to dynamically detect any topic drift and, accordingly, identify any new topics being discussed within these topic-specific communications sessions. If the topic identification module 106 identifies (such as through the natural language processor 202 and the topic embedding processor 204 described above in connection with FIG. 2) one or more new topics being discussed within an ongoing topic-specific communications session, the topic identification module 106 may provide the conversation data corresponding to this topic-specific communications session and the newly identified topics to the topic selection processor 302 to determine whether new topic-specific communications sessions may be facilitated for these newly identified topics. Thus, through this continuous and real-time monitoring of different communications sessions, the user communication system may continuously ensure that no communications session becomes cluttered with communications related to myriad topics. Further, through this continuous and real-time monitoring of different communications sessions, the user communication system may provide users with relevant and topic-specific information, thereby reducing the amount of effort required by the user to identify communications related to these topics and more quickly address any tasks or issues related to these topics.

In some instances, the topic identification module 106 may additionally and continuously monitor these communications to determine whether any communications correspond to existing topics for which other topic-specific communications sessions were established. In the event that the topic identification module 106 determines that one or more communications being exchanged in a particular topic-specific communications session correspond to a different existing topic for which another topic-specific communications session is implemented, the topic identification module 106 may automatically, and dynamically, transfer these communications to this other topic-specific communications session and inform the user of this transfer. This may allow the user to revert to the other topic-specific communications session to continue a conversation related to the other topic. Further, this may ensure that each topic-specific communications session remains specific to the particular topic.

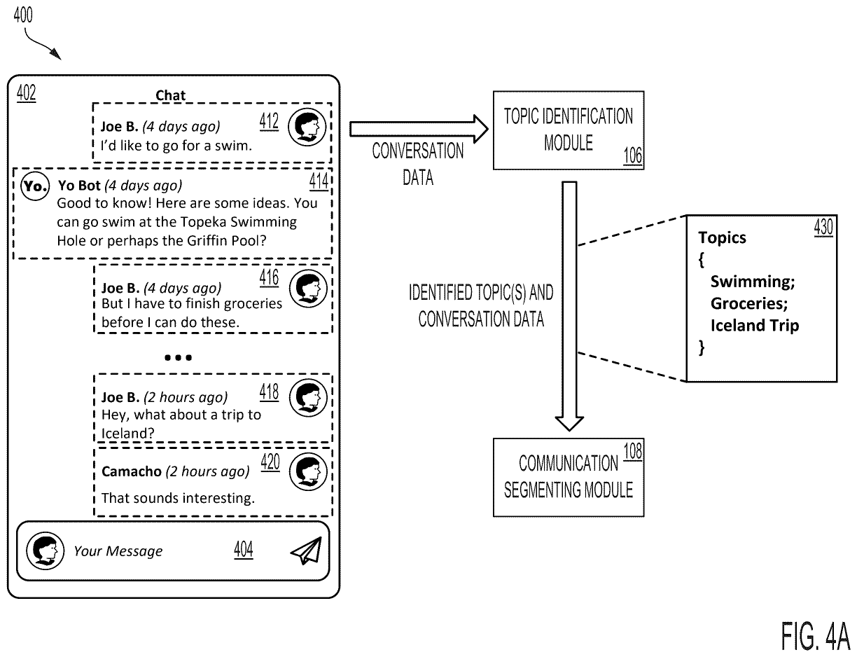

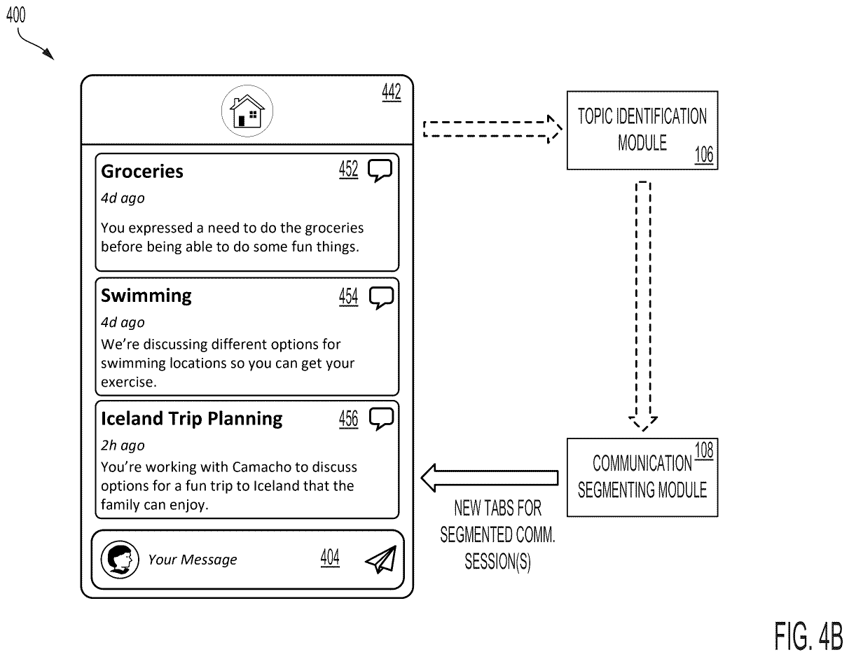

FIGS. 4A and 4B show an illustrative example of an environment 400 in which an ongoing communications session 402 is evaluated in real-time to identify a set of topics 430 being discussed among users and an automated agent and dynamically generating topic-specific communications sessions 452-456 based on the identified set of topics 430 in accordance with at least one embodiment. In the environment 400, and as illustrated in FIG. 4A, a user may be engaged in an ongoing communications session 402 with an automated agent. Through an interface provided by the user communication system, a user may communicate with an automated agent through the ongoing communications session 402 to discuss various topics for which the user may be seeking assistance from the automated agent. For instance, through an input field 404 provided by the user communication system, the user may transmit communications to the automated agent. In response to these communications, the automated agent may dynamically generate a response and communicate this response to the user through the ongoing communications session 402.

As noted above, over time, this ongoing communications session 402 may experience topical drift, whereby the topics of conversation discussed between the user and the automated agent may change over time. This may make it difficult to return to previous topics, as the user may be unable to quickly identify from the ongoing communications session 402 any previously exchanged communications related to these previous topics without significant effort. As illustrated in FIG. 4A, a user has transmitted an initial message 412 indicating that they would like to go for a swim. In response to this message 412, the automated agent communicated a response message 414 providing different ideas corresponding to differing swimming locations that may be of interest to the user. Subsequently, the user has expressed, in message 416, that they are unable to partake in a swim until they have finished their groceries. These messages 412-416, as illustrated in FIG. 4A, were exchanged four days prior during the ongoing communications session 402. Days later, the user has transmitted a message 418 to the automated agent indicating that the user is interested in a trip to Iceland. In response to this message 418, another user engaged in the communications session 402 (i.e., Camacho) has transmitted a message 420 indicating that an Iceland trip sounds interesting. The ongoing communications session 402 illustrated in FIG. 4A demonstrates how an ongoing communications session may evolve over time as myriad communications and exchanged. As the ongoing communications session evolves, the topics discussed through the ongoing communications session may change over time. As these topic shifts occur, any communications previously exchanged with regard to other topics may be buried, making it difficult for the user to return to these older topics through the ongoing communications session 402.

As noted above, the user communication system implements a topic identification module 106 that is configured to dynamically process conversation data corresponding to ongoing communications sessions to identify the topics discussed during these ongoing communications sessions. In an embodiment, the topic identification module 106 monitors the ongoing communications session 402, to obtain in real-time or near real-time any communications exchanged between the users engaged in the communications session (i.e., Joe B. and Camacho) and the automated agent. Further, the topic identification module 106 may continuously process historical communications previously exchanged between these users and the automated agent to dynamically identify any topical shifts and to determine the context of these topical shifts.

As illustrated in FIG. 4A, based on an evaluation of the communications 412-420 exchanged between the different users and the automated agent engaged in the ongoing communications session 402, the topic identification module 106 has identified a set of topics 430 corresponding to the primary user's desire to go for a swim, the primary user's need to complete their grocery shopping, and the primary user's desire to travel to Iceland. As the topic identification module 106 identifies the topics discussed during the ongoing communications session 402, the topic identification module 106 may transmit these identified topics and the conversation data corresponding to the ongoing communications session 402 to the communication segmenting module 108.

The communication segmenting module 108, as noted above, is implemented to dynamically decompose ongoing communications sessions into topic-specific communications sessions according to the different topics identified from the ongoing communications sessions, user preferences, and user cognitive loads. The communication segmenting module 108, in response to receiving conversation data associated with an ongoing communications session 402 and a set of topics identified by the topic identification module 106 based on an evaluation of exchanged communications 412-420, may evaluate the user profiles corresponding to the users engaged in the ongoing communications session 402 (i.e., Joe B. and Camacho) to determine the cognitive load of each of these users. Based on the cognitive load of each of these users, the communication segmenting module 108 may determine the number of distinct topics that may be presented to each user from the ongoing communications session 402. Further, based on this identified number of topics that may be presented to each user, the communication segmenting module 108 may evaluate the set of topics provided by the topic identification module to identify which topics may be presented to each user. For instance, based on the cognitive load score associated with a user, the communication segmenting module 108 may select a number of topics based on the level of urgency for addressing these topics. The level of urgency may be determined based on user characteristics from the user profile (e.g., data corresponding to a user's own prioritization of certain topics) and/or potential risks to the user if certain topics are not addressed. The communication segmenting module 108 may further select a number of topics based on the amount of cognitive load that may be reduced through addressing each of these topics. For instance, if addressing a particular topic may greatly reduce a user's cognitive load, this topic may be selected over another topic that, if addressed, would not have such an impact on the user's cognitive load.

As illustrated in FIG. 4B, the communication segmenting module 108 has automatically generated new topic-specific communications sessions 452-456 corresponding to each topic selected by the communication segmenting module 108 from the topics 430 identified by the topic identification module 106 and based on the user's (i.e., Joe B.'s) cognitive load. For instance, the communication segmenting module 108, through the communications session window 442, may present a tab corresponding to a new topic-specific communications session 452 corresponding to a groceries task topic, a tab corresponding to a new topic-specific communications session 454 corresponding to a swimming topic, and a tab corresponding to a new topic-specific communications session 456 corresponding to an Iceland trip planning topic. In an embodiment, these tabs corresponding to the new topic-specific communications sessions 452-456 can be arranged according to different criteria. For instance, these tabs may be arranged according to the level of urgency of each corresponding topic such that tabs corresponding to new topic-specific communications sessions related to more urgent topics are presented more prominently (e.g., higher within the communications session window 442, presented with highlighting or other distinguishing feature, presented with bold or more prominent text, etc.) within the communications session window 442. As another example, these tabs may be arranged in chronological order and according to when the corresponding topic was discussed during the original ongoing communications session 402.

As noted above, the communication segmenting module 108 may implement one or more LLMs or other generative artificial intelligence processes that are trained to generate a summary of each topic-specific communications session generated from the original ongoing communications session. This summary may be presented to inform the user of the particular topic associated with the topic-specific communications session and of the context of the communications previously exchanged through the original ongoing communications session and related to this topic. The communication segmenting module 108 may use, as input, the conversation data associated with the ongoing communications session 402 and the topics selected by the communication segmenting module 108 for the user to generate summaries corresponding to the topic-specific communications sessions 452-456 associated with these selected topics. The communication segmenting module 108, within the tabs corresponding to the topic-specific communications sessions 452-456 displayed through the communications session window 442, may present these summaries to the user to allow the user to readily discern the context for each of the different topic-specific communications sessions 452-456 generated for the user.

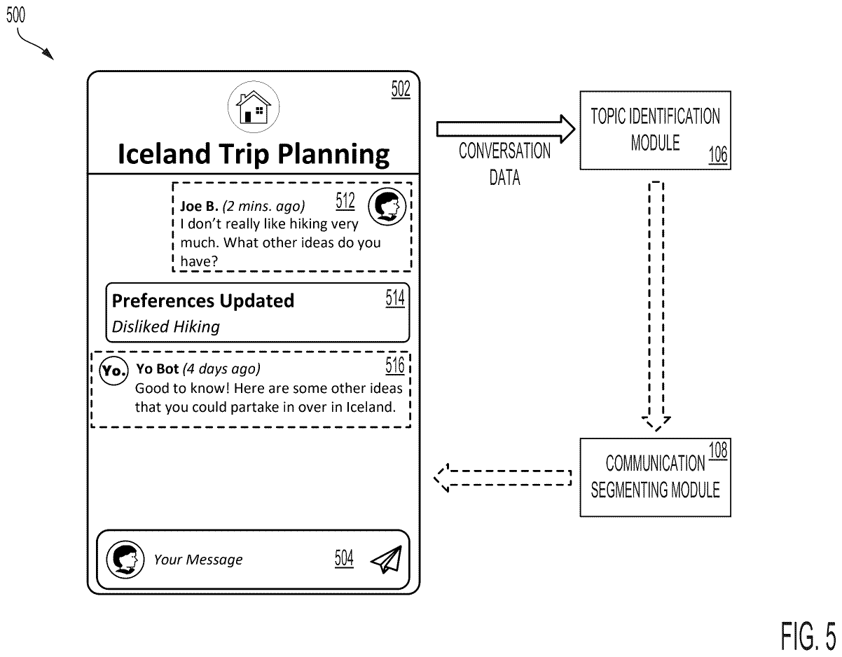

FIG. 5 shows an illustrative example of an environment 500 in which a topic-specific communications session 502 is facilitated in accordance with at least one embodiment. The environment 500 may represent a continuation of the processes described in connection with FIGS. 4A and 4B. For instance, if the user selects the tab corresponding to the topic-specific communications session associated with an Iceland trip planning topic (e.g., topic-specific communications session 456), the user communication system may update the interface to present the topic-specific communications session 502 corresponding to the Iceland trip planning topic. Within the topic-specific communications session 502, the user communication system may provide an input field 504 through which the user may transmit new communications or messages to the automated agent assigned to the topic-specific communications session 502.

As illustrated in FIG. 5, a user, through the topic-specific communications session 502, may submit a communication 512 expressing their dislike of hiking and a desire to identify other ideas that the automated agent may provide with regard to a possible Iceland trip. In an embodiment, the user communication system, through the automated agent, can continuously and automatically monitor user communications exchanged over an communications session (such as topic-specific communications session 502) to identify any data that may be used to update the user profile associated with this user. For instance, user communication system may process communications exchanged by the user over the topic-specific communications session and corresponding to the particular topic and/or to any communications communicated by the automated agent (e.g., suggestions related to the topic, tasks generated based on the topic, etc.) determine a polarity or sentiment related to the topic or automated agent communications. Returning to the illustrative example of FIG. 5, if the user indicates, in a communication 512 to the automated agent, that they do not like hiking and thus would not be interested in any trip plans that including hiking as an activity, the user communication system may ascribe a negative polarity or sentiment to hiking activities. In an embodiment, the user communications system can use these responses to update the user profile associated with the user to update the user's preferences and known behavior characteristics based on the polarity or sentiment expressed in the user's responses provided in the topic-specific communications session.

In an embodiment, if the user communication system updates a user profile associated with the user based on their communications exchanged during the topic-specific communications session 502, the user communication system, through the automated agent, can update the topic-specific communications session 502 to indicate this update. For example, as illustrated in FIG. 5, as a result of the user expressing, in communication 512, that they do not like hiking, the user communication system may update the user profile associated with this user to indicate that the user does not like hiking. Furthermore, the user communication system may update the topic-specific communication session 502 to provide an indication 514 that the user profile has been updated to indicate a dislike of hiking. The automated agent may further provide a communication 516 (such as through the processes described above) to acknowledge the user's communication 512 and to provide alternative ideas for the Iceland trip.

As noted above, as the user exchanges communications with the automated agent over the topic-specific communications session 502, the topic identification module 106 may continuously and in real-time or near real-time monitor communications exchanged through the topic-specific communications session 502 to dynamically detect any topic drift and, accordingly, identify any new topics being discussed within the topic-specific communications session 502. If the topic identification module 106 identifies one or more new topics being discussed within the ongoing topic-specific communication session 502, the topic identification module 106 may provide the conversation data corresponding to this topic-specific communications session and the newly identified topics to the communication segmenting module 108 to determine whether new topic-specific communications sessions may be facilitated for these newly identified topics. Thus, through this continuous and real-time monitoring of the topic-specific communications session, the user communication system may continuously ensure that this topic-specific communications session does not become cluttered with communications related to other unrelated topics.

If the topic identification module 106, through the continuous monitoring of the topic-specific communications session 502, determines that one or more communications correspond to existing topics for which other topic-specific communications sessions were established, the topic identification module 106 may automatically, and dynamically, transfer these communications to this other topic-specific communications session and inform the user of this transfer. This may allow the user to revert to the other topic-specific communications session to continue a conversation related to the other topic. Further, this may ensure that each topic-specific communications session remains specific to the particular topic.

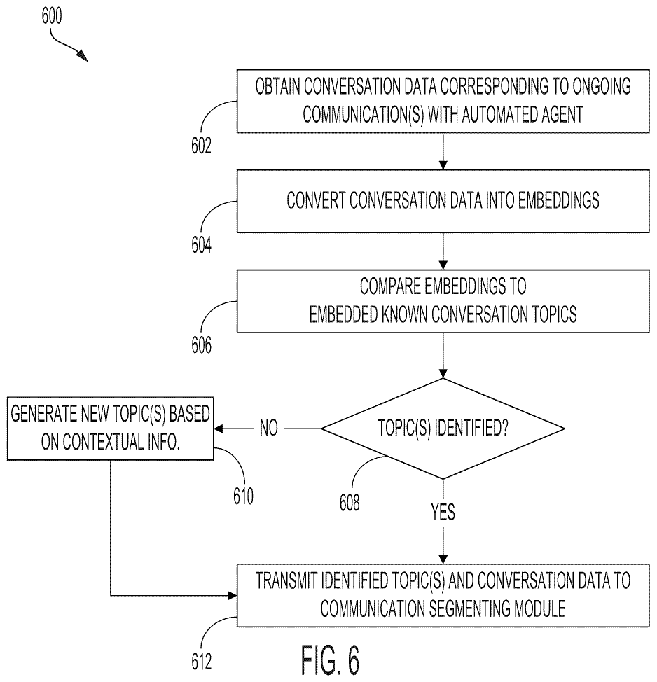

FIG. 6 shows an illustrative example of a process 600 for identifying a set of topics discussed during an ongoing communications session for facilitating new topic-specific communications sessions in accordance with at least one embodiment. The process 600 may be performed by the topic identification module described above in connection with FIGS. 1 and 2. At step 602, the topic identification module may obtain conversation data corresponding to ongoing communications being exchanged between one or more users and an automated agent. For instance, the topic identification module may continuously, and in real-time or near real-time, monitor an ongoing communications session to dynamically detect any communications being exchanged over the ongoing communications session.

At step 604, the topic identification module may convert the obtained conversation data into a set of communication embeddings. As noted above, the topic identification module may implement a natural language processor that is configured to perform NLP or other language parsing on the obtained conversation data to convert the conversation data into a set of communication embeddings. This natural language processor may further obtain historical conversation data corresponding to the ongoing communications session to obtain any previously exchanged communications and any previously identified topics associated with the ongoing communications session. The natural language processor may use the historical conversation data corresponding to the ongoing communications session and the previously identified topics to determine the context of the newly obtained conversation data and based on this context, refine the set of communication embeddings corresponding to the conversation data.

At step 606, the topic identification module may compare the set of communication embeddings to a set of known topic embeddings corresponding to known topics previously identified by the user communication system. The topic identification module, in an embodiment, implements a machine learning algorithm or artificial intelligence that is dynamically trained to compare received sets of communication embeddings to embeddings corresponding to known topics. The topic embeddings corresponding to known topics may be maintained by the user communication system in a known topics datastore or other knowledge base. These known topics may be generated by the user communication system or other entity associated with the user communication system based on different available sources. For instance, the user communication system may evaluate historical conversation data corresponding to prior communications sessions between different users and automated agents to identify any topics associated with these prior communications sessions. The user communication system may annotate these prior communications sessions and generate topic embeddings corresponding to the communications associated with these topics. Further, the user communication system may process feedback from different users corresponding to different topics discussed during communications sessions with different automated agents. This feedback may include indications of automated agent performance in identifying ongoing topics during communications sessions and in providing relevant responses to user communications. Thus, the user communications system may further annotate this feedback and corresponding communications to generate topic embeddings corresponding to these communications.

Through the machine learning algorithm or artificial intelligence, the topic identification module may perform clustering or classification of different communication embeddings in real-time or near real-time as these communication embeddings are obtained. Through this processing of the different communication embeddings, the topic identification module may obtain partial matches among different known topic embeddings from the known topics datastore to determine, at step 608, whether the communication embeddings correspond to any known topics maintained by the user communication system. For instance, the topic identification module may maintain a match threshold whereby if the partial matches do not satisfy the match threshold for any known topic, the topic identification module may determine that the communication embeddings do not correspond to any known topic.

If the topic identification module determines that the communication embeddings do not correspond to any known topic, the topic identification module, at step 610, may dynamically generate one or more new topics based on the contextual information obtained through evaluation of the conversation data corresponding to the ongoing communications session. For instance, the topic identification module may implement one or more LLMs or other generative artificial intelligence processes that are trained in conjunction with RAG to identify topics that accurately reflect the communications exchanged between users and automated agents during ongoing communications sessions. The topic identification module may process the obtained conversation data and any historical communications exchanged through the ongoing communications session using the one or more LLMs or other generative artificial intelligence processes to identify any new topics discussed during the ongoing communications session.

At step 612, the topic identification module may transmit the identified topics and conversation data corresponding to the ongoing communications session to the communication segmenting module implemented by the user communication system. As noted above, the communication segmenting module may evaluate the conversation data and the identified topics according to a user's cognitive load and preferences to select one or more topics for which topic-specific communications sessions may be facilitated. In some instances, if the topic identification module generates, through the one or more LLMs or other generative artificial intelligence processes, one or more new topics based on the obtained conversation data and historical communications exchanged through the ongoing communications session, the topic identification module may dynamically update these one or more LLMs or other generative artificial intelligence processes according to any feedback obtained with regard to these newly generated topics. For example, if a new topic-specific communications session corresponding to a newly generated topic is created and a user provides negative feedback with regard to this new topic-specific communications session (e.g., the user expresses that the new topic-specific communications session is irrelevant to any previous user communications, the user indicates that the topic does not accurately capture any previous user communications, etc.), the topic identification module may dynamically update the datasets used to train the one or more LLMs or other generative artificial intelligence to reduce the likelihood of similar topics being generated for similar communications sessions and corresponding conversation data.

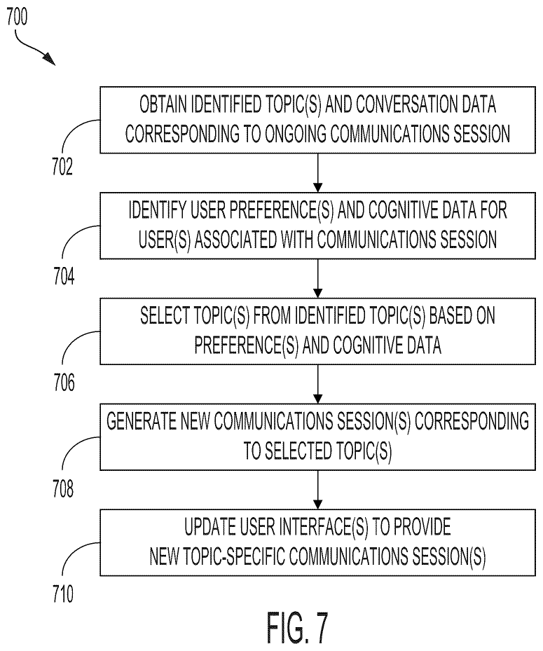

FIG. 7 shows an illustrative example of a process 700 for generating new topic-specific communications sessions based on a set of identified topics from an ongoing communications session, user preferences, and user cognitive load in accordance with at least one embodiment. The process 700 may be performed by the communication segmenting module described above in connection with FIGS. 1 and 3. At step 702, the communication segmenting module may obtain a set of identified topics and conversation data corresponding to an ongoing communications session. The set of identified topics and conversation data may be obtained from the topic identification module, described above and which dynamically processes communications exchanged during an ongoing communications session to identify different topics discussed during the ongoing communications session.

At step 704, the communication segmenting module may identify a set of user preferences and cognitive data for the one or more users associated with the ongoing communications session. For instance, the communication segmenting module may query a user profile datastore to identify user profiles corresponding to the users engaged in the ongoing communications session. As noted above, a user profile may define a set of attributes of the corresponding user that may be used by the user communication system (such as through an automated agent) to determine how best to approach the user in conversation, in recommending tasks and proposals to the user, and in performance of the tasks for the benefit of the user and/or the user's family. These attributes may include a measure of user behavior or preference in delegating certain categories of tasks to others or in performing certain categories of tasks themselves. For instance, a user attribute may provide a score or other metric corresponding to the probability of the user delegating different categories of tasks to others to perform. As another example, a user attribute may provide an indication of a user's preference to be presented with proposals for completion of a task (if being delegated) or to simply allow another to decide for the user. Other member attributes may indicate whether the user is concerned with budgets, with brand recognition, with reviews (e.g., restaurant reviews, product reviews, etc.), with punctuality, with speed of response, and the like. User attributes may further include basic information about the user as provided during an onboarding process.

A user profile associated with a particular user may also be modified by the particular user to provide additional information that may be used to supplement or otherwise modify these user profiles. Returning to an earlier illustrative example, through an application or web portal provided by the user communication system, a user may be provided with a link or other interactive element that may be used by the user to access their user profile. Within the user profile, the user may add, remove, or edit any information within the user profile. The user profile may be divided into various sections corresponding to different user characteristics, such as personal demographics, family composition, home composition, payment information, and the like. The user communication system may automatically populate elements of these various sections based on the user's previously provided responses to the prompts provided by the user communication system during the onboarding process, as well as any responses provided by the user to surveys or questionnaires provided to the user during the onboarding process. Each section of the user profile may further include additional questions or prompts that the user may use to provide additional information that may be used to expand the user profile.

The communication segmenting module may dynamically process the user profiles corresponding to the one or more users engaged in the ongoing communications session to determine the cognitive load of each of these users. For instance, the communication segmenting module may use these user profiles, corresponding tasks associated with the users engaged in the communications session, and the conversation data corresponding to the ongoing communications session as input to a trained machine learning algorithm or artificial intelligence to generate a cognitive load score for each of these users.

At step 706, the communication segmenting module may select one or more topics from the identified topics provided by the topic identification module and based on the identified user preferences and cognitive data. As noted above, a cognitive load score associated with a user may be used to determine the number of distinct topics that may be presented to the user from the ongoing communications session. Returning to an earlier illustrative example, if a user is assigned a high cognitive load score (i.e., the user is exhibiting high levels of stress), the communication segmenting module may determine that the user should be presented with a limited number of different topics to not overburden or overwhelm the user with myriad topics extracted from the ongoing communications session. Additionally, based on this identified number of topics that may be presented to the user, the communication segmenting module may rank the set of topics provided by the topic identification module to identify the topics that may be presented to the user. For instance, based on the cognitive load score associated with the user, the communication segmenting module may rank these topics based on the level of urgency for addressing these topics. The level of urgency may be determined based on user characteristics and/or preferences from the user profile (e.g., data corresponding to a user's own prioritization of certain topics) and/or potential risks to the user if certain topics are not addressed. The communication segmenting module may further rank these topics based on the amount of cognitive load that may be reduced through addressing each of these topics. For instance, if addressing a particular topic may greatly reduce the user's cognitive load, this topic may be assigned a higher rank compared to another topic that, if addressed, would not have such an impact on the user's cognitive load.

At step 708, the communication segmenting module may generate one or more new topic-specific communications sessions corresponding to the selected topics. In some instances, for each new topic-specific communications session, the communication segmenting module may implement a new automated agent that may communicate with a corresponding user with regard to the topic associated with the topic-specific communications session. Alternatively, the new topic-specific communications sessions may be facilitated using the same automated agent used for the original ongoing communications session.

At step 710, the communication segmenting module may update the user interfaces associated with the different users engaged in the original ongoing communications session to provide the new topic-specific communications sessions facilitated for these different users. Returning to the illustrative example provided in FIG. 3, when the new topic-specific communications sessions are initiated by the communication segmenting module, the communication segmenting module may dynamically update the interface to provide, through a communications session window, a set of topic-specific communications session tabs through which a user may access any of these topic-specific communications sessions to review previous communications associated with these topics and engage an automated agent with regard to these topics. These topics may correspond to the different topics of conversation included in the original communications session between the user and the automated agent. As the original ongoing communications session may involve any number of users, the communication segmenting module may select different topics for these users based on their unique user preferences and their cognitive loads. Accordingly, for an ongoing communications session, the communication segmenting module may generate different topic-specific communications sessions for these different users according to the topics selected by the topic selection processor for these users.

As noted above, the communication segmenting module may implement one or more LLMs or other generative artificial intelligence processes that are trained to generate a summary of each topic-specific communications session generated from the original ongoing communications session. This summary may be presented to inform a user of the particular topic associated with the topic-specific communications session and of the context of the communications previously exchanged through the original ongoing communications session and related to this topic. The communication segmenting module may use, as input, the conversation data associated with the ongoing communications session and the topics selected by the communication segmenting module (at step 706) to generate summaries corresponding to the topic-specific communications sessions associated with these selected topics. As noted above, the one or more LLMs or other generative artificial intelligence processes may be trained to perform an extractive, abstractive, or hybrid summarization of this conversation data related to each particular topic. For instance, the one or more LLMs or other generative artificial intelligence process may dynamically evaluate the various communications associated with a particular topic and extract any terms and/or phrases that may be used to construct a summary of the communications related to the topic. As another illustrative example, the one or more LLMs or other generative artificial intelligence process may process the communications associated with the topic and generate a summary based on an evaluation of these communications. This summary may be evaluated according to linguistic metrics (e.g., BLEU scores, language fluency metrics, semantic consistency metrics, etc.) to ensure that the summary is likely to be understood by a user.

These newly-generated, topic-specific communications sessions may be continuously monitored by the topic identification module described above to dynamically detect any topic drift and, accordingly, identify any new topics being discussed within these topic-specific communications sessions. If the topic identification module identifies one or more new topics being discussed within an ongoing topic-specific communications session, the topic identification module may provide the conversation data corresponding to this topic-specific communications session and the newly identified topics to the communication segmenting module to determine whether new topic-specific communications sessions may be facilitated for these newly identified topics. Thus, through this continuous and real-time monitoring of different communications sessions, the user communication system may continuously perform the processes 600 and 700 described above in connection with FIGS. 6 and 7, respectively, to ensure that no communications session becomes cluttered with communications related to myriad topics. Further, through this continuous and real-time monitoring of different communications sessions, the user communication system may provide users with relevant and topic-specific information, thereby reducing the amount of effort required by the user to identify communications related to these topics and more quickly address any tasks or issues related to these topics.

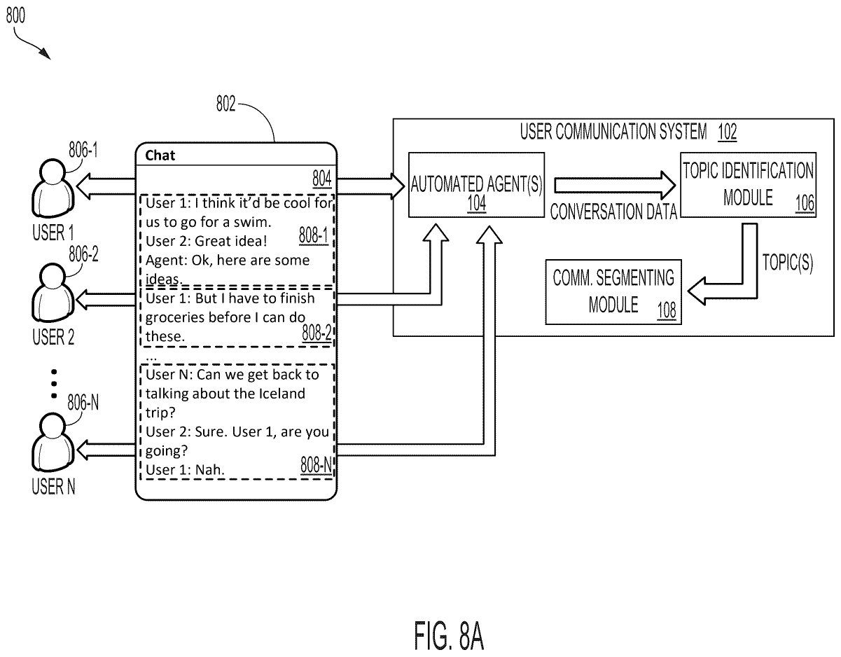

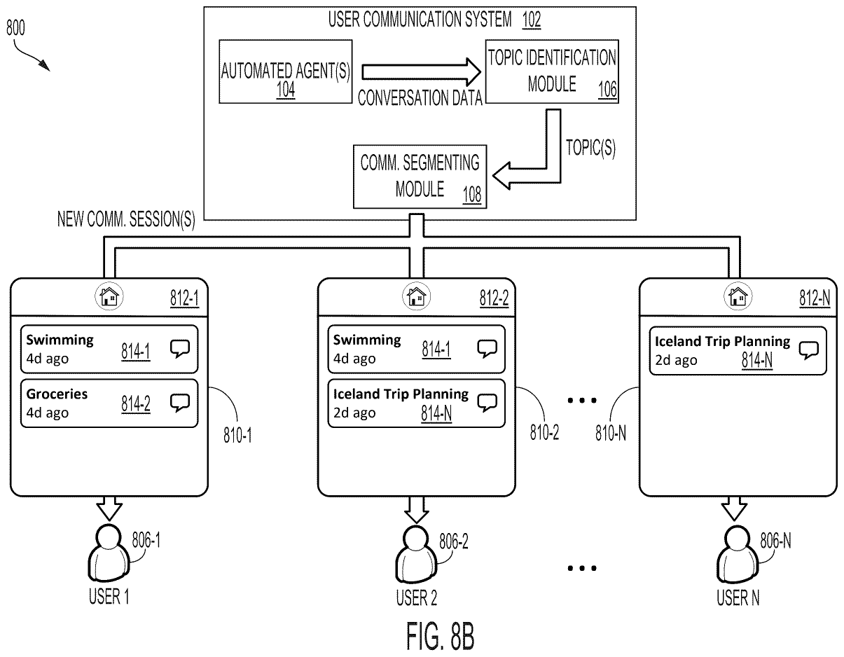

FIGS. 8A-8B show an illustrative example of an environment 800 in which a user communications system 102 dynamically identifies a set of topics from an ongoing communications session 804 associated with multiple users 806-1-806-N and segments the ongoing communications session 804 into a set of topic-specific communications sessions based on the identified set of topics and according to the users 806-1-806-N engaged in each of these topics in accordance with at least one embodiment. In the environment 800, a set of users 806-1-806-N may be engaged in a communications session 804 with one or more automated agents 104 implemented by the user communications system 102. These users 806-1-806-N may be engaged in the communications session 804 to communicate with one another about different topics and/or other issues that may be relevant to a family unit that includes the users 806-1-806-N. Additionally, or alternatively, the users 806-1-806-N may be engaged in the communications session 804 with one or more automated agents 104 to obtain assistance in performing various tasks, to obtain assistance in achieving different goals, to reduce their cognitive load, and the like.

Similar to the environment 100 described above in connection with FIG. 1, the user communication system 102 may provide an application or web service through which users 806-1 -806-N may access an interface 802 for engaging in the communications session 804. This interface 802 may be accessed by each user 806-1-806-N through an application that may be installed and executed from each user's computing device to access, through the interface 802, the user communication system 102. Additionally, or alternatively, a user, through a browser application installed and executed from the user's computing device, may access a website associated with the user communication system 102 and through which the user communication system 102 implements a web service that includes the interface 802. In some instances, to access the interface 802 (either through an application executing on a computing device or through a web service), each user 806-1-806-N may be required to provide a set of credentials (e.g., username/password, a cryptographic key or token, biometric information, etc.) that may be used to authenticate and identify each user.

As illustrated in FIG. 8A, the communications session 804 may be initially centered around a first topic 808-1 (i.e., a plan to go swimming). Through the communications session 804, user 806-1 and 806-2 may be engaged in conversation with an automated agent 104 to plan an outing to go swimming. However, user 806-N may not be involved in the conversation related to the first topic 808-1 (e.g., user 806-N was not involved in the communications session 804 at this time, user 806-N was not interested in such an outing, etc.). Accordingly, this first topic 808-1 may be limited to users 806-1-806-2 and the automated agent 104.

As noted above, over time, communications sessions (such as communications session 804) may experience topical drift, whereby the topics of conversation amongst the users 806-1-806-N and the automated agent 104 may change over time. Further, through this topical drift, different users may be engaged in conversation related to different topics, whereby certain topics may be relevant to some users and not others. As illustrated in FIG. 8, the users 806-1 and 806-2, through the communications session 804, have indicated that they would like to go for a swim, after which the automated agent 104 may provide the users 806-1 and 806-2 with various ideas for completing this swim. Subsequently, the user 806-1 may express that they have to complete their grocery shopping before they are able to partake in a swim. This conversation flow may result in a topical drift from a swimming outing to the need of user 806-1 to complete their grocery shopping (i.e., topic 808-2). This need may be personal to user 806-1 and may be irrelevant to the other users 806-2-806-N associated with the communications session 804. Further, as illustrated in FIG. 8, the communications session 804 may further drift towards a completely unrelated topic (i.e., topic 808-N), namely a conversation amongst users 806-1-806-N and the automated agent 104 regarding a trip to Iceland. This unrelated topic 808-N may be one in which 806-1-806-N may have previously been engaged with in the past and are now returning to after some time. Thus, the communications session 804 may be conducted asynchronously, whereby users 806-1-806-N may be coming in and out of the communications session 804, which may be ongoing in their absence (as others may be carrying on with a conversation through the communications session 804). As a result, this may result in users that should (or should not) be engaged in certain topics potentially missing portions of relevant conversations and losing contextual awareness around these topics over time.

Similar to the processes described above in connection with FIG. 1, the user communication system 102, through a topic identification module 106, may dynamically identify the different topics 808-1-808-N expressed during the communications session 804. The topic identification module 106, as noted above, may continuously monitor the ongoing communications session 804 to obtain in real-time or near real-time any communications exchanged amongst the users 806-1-806-N and the automated agent 104. Further, the topic identification module 106 may continuously process historical communications previously exchanged amongst users 806-1-806-N and the automated agent 104 to dynamically identify the topical shifts from 808-1 through 808-N, determine the context of these topical shifts, and identify which one or more users amongst users 806-1-806-N are engaged in the corresponding topics 808-1-808-N.

In response to a communication or message exchanged by a user through the ongoing communications session 804, the topic identification module 106, through the one or more LLMs or other generative artificial intelligence processes, may dynamically identify a topic that is derived from the known topics datastore or other datastores maintained by the topic identification module 106. Additionally, the topic identification module 106 may associate the topic with the one or more users that have exchanged communications related to the topic. For instance, the topic identification module 106 may annotate each communication exchanged amongst the users 806-1-806-N and the automated agent 104 to indicate the topic associated with the communication (as identified by the topic identification module 106) and the user associated with the communication. The topic identification module 106 may transmit these identified topics, data corresponding to the one or more users associated with each of these identified topics (e.g., user identifiers, etc.), and conversation data corresponding to the ongoing communications session 804 to the communication segmenting module 108 to generate and facilitate topic-specific communications sessions associated with these identified topics.

As noted above, the communication segmenting module 108 may dynamically decompose the ongoing communications session 804 into topic-specific communications sessions according to the different topics identified from the ongoing communications session 804, user preferences corresponding to the users 806-1-806-N engaged in conversation related to these topics, and user cognitive loads corresponding to the users 806-1-806-N. In response to receiving the set of identified topics, data corresponding to the one or more users associated each of these identified topics, and conversation data, the communication segmenting module 108 may query the user profile datastore to identify the user profiles corresponding to each of the users 806-1-806-N engaged in the communications session 804. The communication segmenting module 108, through the aforementioned machine learning algorithm or artificial intelligence implemented by the topic selection processor 302 described above in connection with FIG. 3, may process these user profiles, corresponding tasks associated with the users 806-1-806-N, and the conversation data to generate a cognitive load score for each user 806-1-806-N. As noted above, the cognitive load score associated with a user may be used to determine the number of distinct topics that may be presented to the user from an ongoing communications session.

In an embodiment, the communication segmenting module 108 automatically generates new topic-specific communications sessions corresponding to each selected topic from the set of topics identified by the topic identification module 106. In some instances, for each new topic-specific communications session, the communication segmenting module 108 may implement a new automated agent 104 that may communicate with the users engaged in the new topic-specific communications session (i.e., users identified as having engaged in conversation related to the given topic) with regard to the topic associated with the topic-specific communications session. Alternatively, the new topic-specific communications may be facilitated using the same automated agent 104 used for the ongoing communications session 804.

As illustrated in FIG. 8B, when the topic-specific communications sessions are initiated by the communication segmenting module 108, the communication segmenting module 108 may dynamically update the interfaces 810-1-810-N associated with the users 806-1-806-N, respectively, to provide, through corresponding communications session windows 812-1-812-N, a set of topic-specific communications session tabs 814-1-814-N through which the users 806-1-806-N may access the topic-specific communications sessions to review previous communications associated with these topics and engage with an automated agent 104 and any other users that may be engaged with these topics. For example, as illustrated in FIG. 8B, the communication segmenting module 108 has created topic-specific communications session tabs 814-1-814-N corresponding to a swimming topic, a groceries topic, and an Iceland trip planning topic, respectively. Further, these topic-specific communications session tabs 814-1-814-N may be selectively presented to the users 806-1-806-N through their respective communications session windows 812-1-812-N according to their engagement with these topics. For example, user 806-1 may be provided with the topic-specific communications tab 814-1 corresponding to the swimming topic 808-1 and the topic-specific communications tab 814-2 corresponding to the groceries topic 808-2. User 806-2 may be provided with the topic-specific communications tab 814-1 corresponding to the swimming topic 808-1 and the topic-specific communications tab 814-N corresponding to the Iceland trip topic. Further, user 806-N may be provided with the topic-specific communications tab 814-N corresponding to the Iceland trip topic.

Each user 806-1-806-N, through this partitioning of the communications session 804 into distinct, topic-specific communications sessions, may be presented with topic-specific communications sessions tabs 814-1-814-N corresponding to those topic-specific communications sessions that are relevant to each user. For example, because user 806-1 engaged in conversations related to a plan for an outing to go swimming, the user 806-1 may be added to the topic-specific communications session corresponding to the swimming topic. Further, because the user 806-1 expressed during the communications session 804 that they need to complete their grocery shopping ahead of the swimming outing, the user 806-1 may be added to the topic-specific communications session corresponding to the grocery shopping task. As such, through this user's communications session windows 812-1, the communication segmenting module 108 may present the user 806-1 with the topic-specific communications tab 814-1 and the topic-specific communications tab 814-2. However, because user 806-1 expressed during the ongoing communications session 804 that they are not interested in the Iceland trip, the topic identification module 106 may determine that the Iceland trip topic is not relevant to user 806-1. Thus, the communication segmenting module 108 may omit presenting the topic-specific communications tab 814-N to user 806-1 through the communications session windows 812-1. As another illustrative example, because user 806-2 engaged in conversations related to the swimming outing and the Iceland trip, the communication segmenting module 108 may present the user 806-1 with the topic-specific communications tabs 814-1 and 814-N. For user 806-N, who only engaged in conversations related to the Iceland trip, they may be presented with the topic-specific communications tab 814-N.

As noted above, if a user selects a particular topic-specific communications session tab from their communications session window, the user communication system 102 may update their particular interface to present the topic-specific communications session associated with the selected topic. This user, through this topic-specific communications session, may communicate with an automated agent 104 and any other users that may be engaged in this topic-specific communications session to address or otherwise engage in the particular topic and review any previous communications exchanged through the original communications session 804 to obtain contextual information that may assist the user in recalling any previously provided information with regard to this topic. For example, if user 806-1 selects the topic-specific communications tab 814-1 corresponding to the swimming topic 808-1, the user communications system 102 may update their interface 810-1 to present the topic-specific communications session associated with the swimming outing. Through the topic-specific communications session, the user 806-1 may review any previously exchanged communications associated with this topic 808-1 (such as the communications illustrated in FIG. 8A associated with the topic 808-1), as well as any communications exchanged amongst other users associated with the topic 808-1 (i.e., user 806-2) and the automated agent 104 while the user 806-1 was not present. Additionally, through this topic-specific communications session, the user 806-1 may engage in further conversations with the other users associated with the topic 808-1 and the automated agent 104.

As noted above, the topic identification module 106 continuously monitors communications exchanged through the topic-specific communications sessions to dynamically detect any topic drift and, accordingly, identify any new topics being discussed within these topic-specific communications sessions. If the topic identification module 106 identifies one or more new topics being discussed within an ongoing topic-specific communications session, the topic identification module 106 may provide the conversation data corresponding to this topic-specific communications session, the newly identified topics, and data corresponding to the one or more users associated with each of these identified topics to the communication segmenting module 108 to determine whether new topic-specific communications sessions may be facilitated for these newly identified topics and corresponding users. Thus, through this continuous and real-time monitoring of different communications sessions, the user communication system 102 may continuously ensure that no communications session becomes cluttered with communications related to myriad topics. Further, through this continuous and real-time monitoring of different communications sessions, the user communication system 102 may provide users with relevant and topic-specific information, thereby reducing the amount of effort required by users 806-1-806-N to identify communications related to these topics and more quickly address any tasks or issues related to these topics.

Further, the topic identification module 106 may continuously monitor these communications to determine whether any communications correspond to existing topics for which other topic-specific communications sessions were established. In the event that the topic identification module 106 determines that one or more communications being exchanged in a particular topic-specific communications session correspond to a different existing topic for which another topic-specific communications session is implemented, the topic identification module 106 may automatically, and dynamically, transfer these communications to this other topic-specific communications session and inform the users engaged in the topic-specific communications session of this transfer. This may allow these users to revert to the other topic-specific communications session to continue a conversation related to the other topic. Further, this may ensure that each topic-specific communications session remains specific to the particular topic.

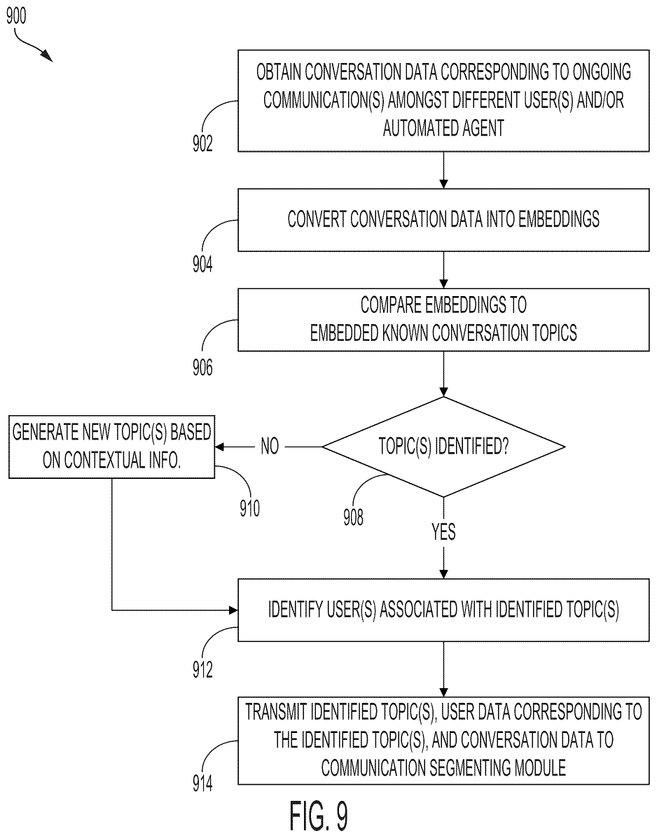

FIG. 9 shows an illustrative example of a process 900 for identifying a set of topics discussed during an ongoing communications session and amongst a set of users for facilitating new topic-specific communications sessions according to user engagement in the set of topics in accordance with at least one embodiment. The process 900 may be performed by the topic identification module described above in connection with FIGS. 1-2 and 8A-8B. The process 900 may include similar steps to that of the process 600 described above in connection with FIG. 6. For example, step 902 may be similar to step 602 of the process 600, whereby the topic identification module may obtain conversation data corresponding to ongoing communications being exchanged amongst different users and an automated agent. Further, at step 904, the topic identification module may convert the obtained conversation data into a set of communication embeddings. As noted above, the topic identification module may implement a natural language processor that is configured to perform NLP or other language parsing on the obtained conversation data to convert the conversation data into a set of communication embeddings. This natural language processor may further obtain historical conversation data corresponding to the ongoing communications session to obtain any previously exchanged communications and any previously identified topics associated with the ongoing communications session. The natural language processor may use the historical conversation data corresponding to the ongoing communications session and the previously identified topics to determine the context of the newly obtained conversation data and based on this context, refine the set of communication embeddings corresponding to the conversation data.

At step 906, the topic identification module may compare the set of communication embeddings to a set of known topic embeddings corresponding to known topics previously identified by the user communication system. Through the processing of the different communication embeddings, the topic identification module may obtain partial matches among different known topic embeddings from the known topics datastore to determine, at step 908, whether the communication embeddings correspond to any known topics maintained by the user communication system. For instance, the topic identification module may maintain a match threshold whereby if the partial matches do not satisfy the match threshold for any known topic, the topic identification module may determine that the communication embeddings do not correspond to any known topic.

If the topic identification module determines that the communication embeddings do not correspond to any known topic, the topic identification module, at step 910, may dynamically generate one or more new topics based on the contextual information obtained through evaluation of the conversation data corresponding to the ongoing communications session. As noted above, the topic identification module may implement one or more LLMs or other generative artificial intelligence processes that are trained in conjunction with RAG to identify topics that accurately reflect the communications exchanged between users and automated agents during ongoing communications sessions. The topic identification module may process the obtained conversation data and any historical communications exchanged through the ongoing communications session using the one or more LLMs or other generative artificial intelligence processes to identify any new topics discussed during the ongoing communications session.

At step 912, the topic identification module may identify the one or more users that associated with each of the identified topics. For instance, the topic identification module may identify, from each communication or message associated with an identified topic, the user that submitted the communication or message. As an illustrative example, a communication or message that is transmitted by a particular user through the ongoing communications session may be annotated to indicate a user identifier corresponding to the particular user. The topic identification module may parse this communication or message to extract this user identifier and accordingly identify the user that submitted the communication or message.

At step 914, the topic identification module may transmit the identified topics, user data corresponding to the identified topics (e.g., user identifiers, etc.), and conversation data corresponding to the ongoing communications session to the communication segmenting module implemented by the user communication system. As noted above, the communication segmenting module may evaluate the conversation data and the identified topics according to a user's cognitive load and preferences to select one or more topics for which topic-specific communications sessions may be facilitated. In some instances, if the topic identification module generates, through the one or more LLMs or other generative artificial intelligence processes, one or more new topics based on the obtained conversation data and historical communications exchanged through the ongoing communications session, the topic identification module may dynamically update these one or more LLMs or other generative artificial intelligence processes according to any feedback obtained with regard to these newly generated topics. For example, if a new topic-specific communications session corresponding to a newly generated topic is created and a user provides negative feedback with regard to this new topic-specific communications session (e.g., the user expresses that the new topic-specific communications session is irrelevant to any previous user communications, the user indicates that the topic does not accurately capture any previous user communications, etc.), the topic identification module may dynamically update the datasets used to train the one or more LLMs or other generative artificial intelligence to reduce the likelihood of similar topics being generated for similar communications sessions and corresponding conversation data.

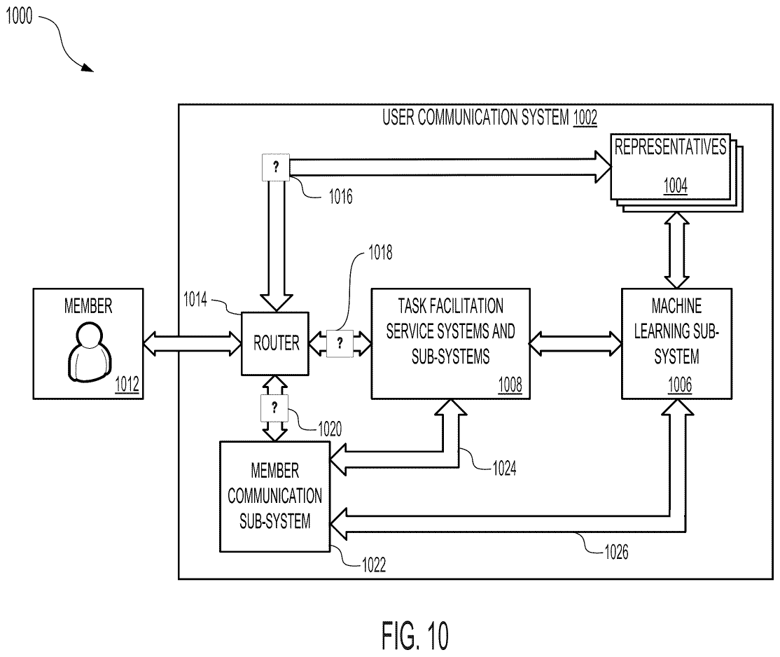

FIG. 10 shows an illustrative example of an environment 1000 in which communications with members are processed in accordance with at least one embodiment. In an embodiment, operations performed by representatives 1004 are partially and/or fully performed using one or more machine learning algorithms, artificial intelligence systems and/or computational models. For example, as the representatives 1004 perform or otherwise coordinate performance of tasks on behalf of a member 1012, the task facilitation service 1002 may update a profile of the member 1012 and/or a computational model of the profile of the member 1012.

In an embodiment, as the representatives 1004 perform or otherwise coordinate performance of tasks on behalf of a member 1012, the task facilitation service 1002 updates a profile of the member 1012 and/or a computational model of the profile of the member 1012 continuously. For example, as a member 1012 communicates with a system of the task facilitation service 1002, the task facilitation service 1002 may update the profile of the member 1012 and/or a computational model of the profile of the member 1012 continuously during the course of the interaction.

In an embodiment, as the representatives 1004 perform or otherwise coordinate performance of tasks on behalf of a member 1012, the task facilitation service 1002 updates a profile of the member 1012 and/or a computational model of the profile of the member 1012 dynamically. For example, as a task is performed on behalf of a member 1012, a vendor performing the task may provide regular updates to the task facilitation service 1002 and the task facilitation service 1002 may update the profile of the member 1012 and/or a computational model of the profile of the member 1012 dynamically at each update from the vendor.

In an embodiment, as the representatives 1004 perform or otherwise coordinate performance of tasks on behalf of a member 1012, the task facilitation service 1002 updates a profile of the member 1012 and/or a computational model of the profile of the member 1012 automatically. For example, when a proposal is generated for the member, the task facilitation service 1002 may update the profile of the member 1012 and/or a computational model of the profile of the member 1012 automatically as part of the proposal generation process.

In an embodiment, as the representatives 1004 perform or otherwise coordinate performance of tasks on behalf of a member 1012, the task facilitation service 1002 updates a profile of the member 1012 and/or a computational model of the profile of the member 1012 in real-time. For example, when a member 1012 accepts a proposal, the task facilitation service 1002 may update the profile of the member 1012 and/or a computational model of the profile of the member 1012 at the time that the proposal acceptance is provided, rather than delaying the update.

In an embodiment, the task facilitation service 1002 updates a profile of the member 1012 and/or a computational model of the profile of the member 1012 using a machine learning sub-system 1006 of the task facilitation service 1002. In an embodiment, a machine learning sub-system 1006 is a component of the task facilitation service 1002 that is configured to implement machine learning algorithms, artificial intelligence systems, and/or computation models. In an example, a machine learning sub-system 1006 may use various algorithms to train a machine learning model using sample and/or live data. Additionally, a machine learning sub-system 1006 may update the machine learning model as new data is received. In another example, the machine learning sub-system 1006 may train and/or update various artificial intelligence systems or generate, train and/or update various computational models. For example, a computational model of the profile of the member 1012 may be generated, trained and/or updated by the machine learning sub-system 1006 as new information is received about the member 1012.

In an embodiment, after the profile of the member 1012 and/or a computational model of the profile of the member 1012 has been updated over a period of time (e.g., six months, a year, etc.) and/or over a set of tasks (e.g., twenty tasks, thirty tasks, etc.), systems of the task facilitation service 1002 (e.g., a task recommendation system) utilize one or more machine learning algorithms, artificial intelligence systems and/or computational models to generate new tasks continuously, automatically, dynamically, and in real-time. For example, the task recommendation system may generate new tasks based on the various attributes of the member's profile (e.g., historical data corresponding to member-representative communications, member feedback corresponding to representative performance and presented tasks/proposals, etc.) with or without representative interaction. In an embodiment, systems of task facilitation service 1002 (e.g., a task recommendation system) can automatically communicate with the member 1012 to obtain any additional information needed and can also generate proposals that may be presented to the member 1012 for performance of these tasks.

In the example illustrated in FIG. 10, communications between the member 1012 and the task facilitation service 1002 may be routed to one or more entities within the task facilitation service 1002. The example illustrated in FIG. 10 shows a communication router 1014 (referred to in the illustration as a “router”) however, as may be contemplated and as illustrated in FIG. 10, the router 1014 is an abstract representation of one or more techniques for routing communications between entities. Accordingly, communications from the member 1012 to the task facilitation service 1002 may be routed to one or more entities of the task facilitation service and communications from the one or more entities of the task facilitation service 1002 may be routed back to the member 1012.

In the example illustrated in FIG. 10, the representatives 1004 can monitor communications between task facilitation service systems and/or sub-systems 1008 and the member 1012 to ensure that the interaction maintains a positive polarity as described herein because the communications can be routed 1016 to the representatives 1004 and also routed 1018 to task facilitation service systems and/or sub-systems 1008. For example, if a member 1012 is interacting with the task recommendation system, the representatives 1004 can determine whether the member 1012 is satisfied with the interaction. If the representatives 1004 determine that the conversation has a negative polarity (e.g., that the member 1012 is not satisfied with the interaction), the representatives 1004 may intervene to improve the interaction.

Similarly, other interactions between task facilitation service systems and/or sub-systems 1008 and the member 1012 may be routed 1020 to a member communication sub-system 1022 which may be configured to monitor the interactions between task facilitation service systems and/or sub-systems 1008 and the member 1012. In an embodiment, the member communication sub-system 1022 can be configured to intercept the interactions between task facilitation service systems and/or sub-systems 1008 and the member 1012 (using, for example, the router 1014). In such an embodiment, all such interactions can be routed 1020 between the member 1012 and the member communication sub-system 1022 and can be routed 1024 between the member communication sub-system 1022 and the task facilitation service systems and/or sub-systems 1008. In such an embodiment, interactions between the task facilitation service systems and/or sub-systems 1008 and the member 1012 may not be routed 1018 directly. In such an embodiment, the representatives 1004 may still monitor interactions between task facilitation service systems and/or sub-systems 1008 and the member 1012 to ensure that the interaction maintains a positive polarity as described above (e.g., by routing 1016 the interactions to the representatives 1004).

In an embodiment, the representatives 1004 can interact with the machine learning sub-system 1006 to update the profile of the member indicating changing member preferences based on an interaction between the representatives 1004 the member 1012. In an embodiment, the task facilitation service systems and/or sub-systems 1008 can interact with the machine learning sub-system 1006 to update the profile of the member when, for example, a proposal is accepted or rejected. Additionally, as illustrated in FIG. 10, the interactions between the task facilitation service 1002 and the member 1012 can be additionally routed 1026 between the member communication sub-system 1022 and the machine learning sub-system 1006. Accordingly, interactions between the member 1012 and, for example, a proposal creation sub-system may be used to update the profile of the member as a proposal is created.

Thus, unlike automated customer service systems and environments, wherein the systems and environment may have little or no knowledge of users interacting with agents and/or other automated systems, task facilitation service systems and/or sub-systems 1008 can update the profile of the member 1012 and/or a computational model of the profile of the member 1012 continuously, dynamically, automatically, and/or in real-time. For example, task facilitation service systems and/or sub-systems 1008 can update the profile of the member 1012 and/or a computational model of the profile of the member 1012 using the machine learning sub-system 1006 as described herein. Accordingly, task facilitation service systems and/or sub-systems 1008 can update the profile of the member 1012 and/or a computational model of the profile of the member 1012 to provide up-to-date information about the member based on the member's automatic interaction with the task facilitation service 1002, based on the member's interaction with the representative 1004, and/or based on tasks performed on behalf of the member 1012 over time. This information may also be updated continuously, automatically, dynamically, and/or in real-time as tasks and/or proposals are created, proposed, and performed for the member 1012. This information may also be used by the task facilitation service 1002 to anticipate, identify, and present appropriate or intelligent interactions with the member 1012 (e.g., in response to member 1012 queries, needs, and/or goals).

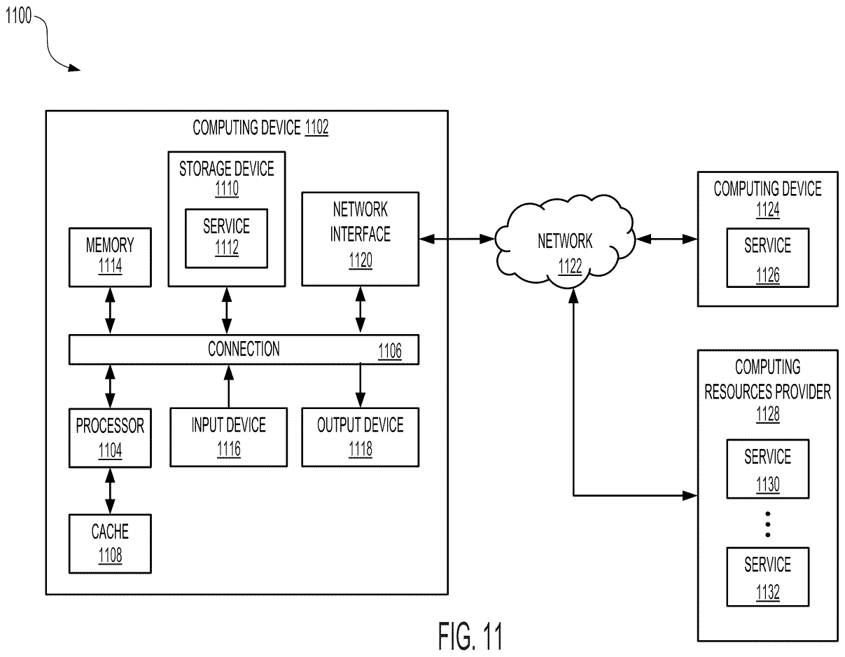

FIG. 11 illustrates a computing system architecture 1100, including various components in electrical communication with each other, in accordance with some embodiments. The example computing system architecture 1100 illustrated in FIG. 11 includes a computing device 1102, which has various components in electrical communication with each other using a connection 1106, such as a bus, in accordance with some implementations. The example computing system architecture 1100 includes a processing unit 1104 that is in electrical communication with various system components, using the connection 1106, and including the system memory 1114. In some embodiments, the system memory 1114 includes read-only memory (ROM), random-access memory (RAM), and other such memory technologies including, but not limited to, those described herein. In some embodiments, the example computing system architecture 1100 includes a cache 1108 of high-speed memory connected directly with, in close proximity to, or integrated as part of the processor 1104. The system architecture 1100 can copy data from the memory 1114 and/or the storage device 1110 to the cache 1108 for quick access by the processor 1104. In this way, the cache 1108 can provide a performance boost that decreases or eliminates processor delays in the processor 1104 due to waiting for data. Using modules, methods and services such as those described herein, the processor 1104 can be configured to perform various actions. In some embodiments, the cache 1108 may include multiple types of cache including, for example, level one (L1) and level two (L2) cache. The memory 1114 may be referred to herein as system memory or computer system memory. The memory 1114 may include, at various times, elements of an operating system, one or more applications, data associated with the operating system or the one or more applications, or other such data associated with the computing device 1102.

Other system memory 1114 can be available for use as well. The memory 1114 can include multiple different types of memory with different performance characteristics. The processor 1104 can include any general purpose processor and one or more hardware or software services, such as service 1112 stored in storage device 1110, configured to control the processor 1104 as well as a special-purpose processor where software instructions are incorporated into the actual processor design. The processor 1104 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1104 can be a microprocessor, a microcontroller, a digital signal processor (“DSP”), or a combination of these and/or other types of processors. In some embodiments, the processor 1104 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1100, an input device 1116 can represent any number of input mechanisms, such as a microphone for speech, a touch-sensitive screen for gesture or graphical input, keyboard, mouse, motion input, pen, and other such input devices. An output device 1118 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1100. In some embodiments, the input device 1116 and/or the output device 1118 can be coupled to the computing device 1102 using a remote connection device such as, for example, a communication interface such as the network interface 1120 described herein. In such embodiments, the communication interface can govern and manage the input and output received from the attached input device 1116 and/or output device 1118. As may be contemplated, there is no restriction on operating on any particular hardware arrangement and accordingly the basic features here may easily be substituted for other hardware, software, or firmware arrangements as they are developed.

In some embodiments, the storage device 1110 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1110 can include hardware and/or software services such as service 1112 that can control or configure the processor 1104 to perform one or more functions including, but not limited to, the methods, processes, functions, systems, and services described herein in various embodiments. In some embodiments, the hardware or software services can be implemented as modules. As illustrated in example computing system architecture 1100, the storage device 1110 can be connected to other parts of the computing device 1102 using the system connection 1106. In an embodiment, a hardware service or hardware module such as service 1112, that performs a function can include a software component stored in a non-transitory computer-readable medium that, in connection with the necessary hardware components, such as the processor 1104, connection 1106, cache 1108, storage device 1110, memory 1114, input device 1116, output device 1118, and so forth, can carry out the functions such as those described herein.

The disclosed processed for generating and executing experience recommendations can be performed using a computing system such as the example computing system illustrated in FIG. 11, using one or more components of the example computing system architecture 1100. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for generating and executing experience recommendations described herein by, for example, executing code using a processor such as processor 1104 wherein the code is stored in memory such as memory 1114 as described herein. One or more of a user device, a provider server or system, a database system, or other such devices, services, or systems may include some or all of the components of the computing system such as the example computing system illustrated in FIG. 11, using one or more components of the example computing system architecture 1100 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1128. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1104 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1114 can be coupled to the processor 1104 by, for example, a connector such as connector 1106, or a bus. As used herein, a connector or bus such as connector 1106 is a communications system that transfers data between components within the computing device 1102 and may, in some embodiments, be used to transfer data between computing devices. The connector 1106 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 1114 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1114 can also include magnetic or optical data storage media including read-only (e.g., CD ROM and DVD ROM) or otherwise (e.g., CD or DVD). The memory can be local, remote, or distributed.

As described above, the connector 1106 (or bus) can also couple the processor 1104 to the storage device 1110, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1110. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1106 can also couple the processor 1104 to a network interface device such as the network interface 1120. The interface can include one or more of a modem or other such network interfaces including, but not limited to those described herein. It will be appreciated that the network interface 1120 may be considered to be part of the computing device 1102 or may be separate from the computing device 1102. The network interface 1120 can include one or more of an analog modem, Integrated Services Digital Network (ISDN) modem, cable modem, token ring interface, satellite transmission interface, or other interfaces for coupling a computer system to other computer systems. In some embodiments, the network interface 1120 can include one or more input and/or output (I/O) devices. The I/O devices can include, by way of example but not limitation, input devices such as input device 1116 and/or output devices such as output device 1118. For example, the network interface 1120 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and decendents, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1102 can be connected to one or more additional computing devices such as computing device 1124 via a network 1122 using a connection such as the network interface 1120. In such embodiments, the computing device 1124 may execute one or more services 1126 to perform one or more functions under the control of, or on behalf of, programs and/or services operating on computing device 1102. In some embodiments, a computing device such as computing device 1124 may include one or more of the types of components as described in connection with computing device 1102 including, but not limited to, a processor such as processor 1104, a connection such as connection 1106, a cache such as cache 1108, a storage device such as storage device 1110, memory such as memory 1114, an input device such as input device 1116, and an output device such as output device 1118. In such embodiments, the computing device 1124 can carry out the functions such as those described herein in connection with computing device 1102. In some embodiments, the computing device 1102 can be connected to a plurality of computing devices such as computing device 1124, each of which may also be connected to a plurality of computing devices such as computing device 1124. Such an embodiment may be referred to herein as a distributed computing environment.

The network 1122 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1122 can be wired connections, wireless connections, or combinations thereof. Communications via the network 1122 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1122, within the computing device 1102, within the computing device 1124, or within the computing resources provider 1128 can include information, which also may be referred to herein as content. The information may include text, graphics, audio, video, haptics, and/or any other information that can be provided to a user of the computing device such as the computing device 1102. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1102 and presented to a user of the computing device 1102 using forms that are perceptible via sight, sound, smell, taste, touch, or other such mechanisms. In some embodiments, communications over the network 1122 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1102 and/or the computing device 1124 can be connected to a computing resources provider 1128 via the network 1122 using a network interface such as those described herein (e.g. network interface 1120). In such embodiments, one or more systems (e.g., service 1130 and service 1132) hosted within the computing resources provider 1128 (also referred to herein as within “a computing resources provider environment”) may execute one or more services to perform one or more functions under the control of, or on behalf of, programs and/or services operating on computing device 1102 and/or computing device 1124. Systems such as service 1130 and service 1132 may include one or more computing devices such as those described herein to execute computer code to perform the one or more functions under the control of, or on behalf of, programs and/or services operating on computing device 1102 and/or computing device 1124.

For example, the computing resources provider 1128 may provide a service, operating on service 1130 to store data for the computing device 1102 when, for example, the amount of data that the computing device 1102 exceeds the capacity of storage device 1110. In another example, the computing resources provider 1128 may provide a service to first instantiate a virtual machine (VM) on service 1132, use that VM to access the data stored on service 1132, perform one or more operations on that data, and provide a result of those one or more operations to the computing device 1102. Such operations (e.g., data storage and VM instantiation) may be referred to herein as operating “in the cloud,” “within a cloud computing environment,” or “within a hosted virtual machine environment,” and the computing resources provider 1128 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1128 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1130 and service 1132 may implement versions of various services (e.g., the service 1112 or the service 1126) on behalf of, or under the control of, computing device 1102 and/or computing device 1124. Such implemented versions of various services may involve one or more virtualization techniques so that, for example, it may appear to a user of computing device 1102 that the service 1112 is executing on the computing device 1102 when the service is executing on, for example, service 1130. As may also be contemplated, the various services operating within the computing resources provider 1128 environment may be distributed among various systems within the environment as well as partially distributed onto computing device 1124 and/or computing device 1102.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1102) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 7-8). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1102.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
receiving conversation data, wherein the conversation data is received during an ongoing communications session among a set of users and an automated agent;
dynamically processing the conversation data into a set of communication embeddings, wherein the set of communication embeddings is obtained through language processing of the conversation data;
identifying a set of topic embeddings, wherein the set of topic embeddings corresponds to one or more topics relevant to the ongoing communications session, and wherein the set of topic embeddings is identified through processing of the set of communication embeddings and different topic embeddings according to a set of similarity vectors;
generating one or more new communications sessions, wherein the one or more new communications sessions are generated by a generative pre-trained algorithm according to the set of topic embeddings;
updating one or more interfaces associated with the set of users to facilitate the one or more new communications sessions, wherein the one or more interfaces are updated according to the one or more topics associated with the set of topic embeddings; and
updating the generative pre-trained algorithm according to feedback associated with the one or more new communications sessions.

2. The computer-implemented method of claim 1, further comprising:
assigning one or more new automated agents to the one or more new communications sessions, wherein the one or more new automated agents are assigned based on the one or more topics.

3. The computer-implemented method of claim 1, wherein the conversation data includes a user input corresponding to a particular topic of interest to a user of the set of users, and wherein the set of topic embeddings corresponds to at least the particular topic.

4. The computer-implemented method of claim 1, further comprising:
processing the conversation data through a trained machine learning algorithm to generate one or more recommendations corresponding to a set of goals; and
generating another new communications session based on the set of goals.

5. The computer-implemented method of claim 1, further comprising:
processing the conversation data through one or more trained large language models (LLMs) to generate one or more summaries corresponding to communications associated with the one or more topics; and
providing the one or more summaries through the one or more interfaces.

6. The computer-implemented method of claim 1, wherein generating the one or more new communications sessions further includes:
determining a set of cognitive load scores associated with the set of users, wherein the set of cognitive load scores is determined based on existing tasks and user profiles associated with the set of users; and
selecting a set of topics according to the set of cognitive load scores, wherein the one or more new communications sessions correspond to the set of topics.

7. The computer-implemented method of claim 1, further comprising:
continuously monitoring the one or more new communications sessions to detect new topic embeddings associated with the one or more new communications sessions; and
facilitating additional communications sessions corresponding to the new topic embeddings.

8. A system, comprising:
one or more processors; and
memory storing thereon instructions that, as a result of being executed by the one or more processors, cause the system to:
receive conversation data, wherein the conversation data is received during an ongoing communications session among a set of users and an automated agent;
dynamically process the conversation data into a set of communication embeddings, wherein the set of communication embeddings is obtained through language processing of the conversation data;
identify a set of topic embeddings, wherein the set of topic embeddings corresponds to one or more topics relevant to the ongoing communications session, and wherein the set of topic embeddings is identified through processing of the set of communication embeddings and different topic embeddings according to a set of similarity vectors;
generate one or more new communications sessions, wherein the one or more new communications sessions are generated by a generative pre-trained algorithm according to the set of topic embeddings;
update one or more interfaces associated with the set of users to facilitate the one or more new communications sessions, wherein the one or more interfaces are updated according to the one or more topics associated with the set of topic embeddings; and
update the generative pre-trained algorithm according to feedback associated with the one or more new communications sessions.

9. The system of claim 8, wherein the instructions further cause the system to:
assign one or more new automated agents to the one or more new communications sessions, wherein the one or more new automated agents are assigned based on the one or more topics.

10. The system of claim 8, wherein the conversation data includes a user input corresponding to a particular topic of interest to a user of the set of users, and wherein the set of topic embeddings corresponds to at least the particular topic.

11. The system of claim 8, wherein the instructions further cause the system to:
process the conversation data through a trained machine learning algorithm to generate one or more recommendations corresponding to a set of goals; and
generate another new communications session based on the set of goals.

12. The system of claim 8, wherein the instructions further cause the system to:
process the conversation data through one or more trained large language models (LLMs) to generate one or more summaries corresponding to communications associated with the one or more topics; and
provide the one or more summaries through the one or more interfaces.

13. The system of claim 8, wherein the instructions that cause the system to generate the one or more new communications sessions further cause the system to:
determine a set of cognitive load scores associated with the set of users, wherein the set of cognitive load scores is determined based on existing tasks and user profiles associated with the set of users; and
select a set of topics according to the set of cognitive load scores, wherein the one or more new communications sessions correspond to the set of topics.

14. The system of claim 8, wherein the instructions further cause the system to:
continuously monitor the one or more new communications sessions to detect new topic embeddings associated with the one or more new communications sessions; and
facilitate additional communications sessions corresponding to the new topic embeddings.

15. A non-transitory computer-readable storage medium storing thereon executable instructions that, as a result of being executed by one or more processors of a computer system, cause the computer system to:
receive conversation data, wherein the conversation data is received during an ongoing communications session among a set of users and an automated agent;
dynamically process the conversation data into a set of communication embeddings, wherein the set of communication embeddings is obtained through language processing of the conversation data;
identify a set of topic embeddings, wherein the set of topic embeddings corresponds to one or more topics relevant to the ongoing communications session, and wherein the set of topic embeddings is identified through processing of the set of communication embeddings and different topic embeddings according to a set of similarity vectors;
generate one or more new communications sessions, wherein the one or more new communications sessions are generated by a generative pre-trained algorithm according to the set of topic embeddings;
update one or more interfaces associated with the set of users to facilitate the one or more new communications sessions, wherein the one or more interfaces are updated according to the one or more topics associated with the set of topic embeddings; and
update the generative pre-trained algorithm according to feedback associated with the one or more new communications sessions.

16. The non-transitory computer-readable storage medium of claim 15, wherein the executable instructions further cause the computer system to:
assign one or more new automated agents to the one or more new communications sessions, wherein the one or more new automated agents are assigned based on the one or more topics.

17. The non-transitory computer-readable storage medium of claim 15, wherein the conversation data includes a user input corresponding to a particular topic of interest to a user of the set of users, and wherein the set of topic embeddings corresponds to at least the particular topic.

18. The non-transitory computer-readable storage medium of claim 15, wherein the executable instructions further cause the computer system to:
process the conversation data through a trained machine learning algorithm to generate one or more recommendations corresponding to a set of goals; and
generate another new communications session based on the set of goals.

19. The non-transitory computer-readable storage medium of claim 15, wherein the executable instructions further cause the computer system to:
process the conversation data through one or more trained large language models (LLMs) to generate one or more summaries corresponding to communications associated with the one or more topics; and
provide the one or more summaries through the one or more interfaces.

20. The non-transitory computer-readable storage medium of claim 15, wherein the executable instructions that cause the computer system to generate the one or more new communications sessions further cause the computer system to:
determine a set of cognitive load scores associated with the set of users, wherein the set of cognitive load scores is determined based on existing tasks and user profiles associated with the set of users; and
select a set of topics according to the set of cognitive load scores, wherein the one or more new communications sessions correspond to the set of topics.

21. The non-transitory computer-readable storage medium of claim 15, wherein the executable instructions further cause the computer system to:
continuously monitor the one or more new communications sessions to detect new topic embeddings associated with the one or more new communications sessions; and
facilitate additional communications sessions corresponding to the new topic embeddings.
